(19) United States
(12) Patent Application Publication
(10) Pub. No.: US 2026/0059361 A1
(43) Pub. Date: Feb. 26, 2026

(54) ACKNOWLEDGEMENT STATUS REPORT

(71) Applicant: QUALCOMM Incorporated, San Diego, CA (US)

(72) Inventors: Mostafa KHOSHNEVISAN, San Diego, CA (US); Jing SUN, San Diego, CA (US)

(21) Appl. No.: 18/811,605

(22) Filed: Aug. 21, 2024

(51) Int. Cl. H04W 24/10; H04L 5/00

(52) U.S. Cl. CPC H04W 24/10; H04L 5/0055

(57) ABSTRACT

Various aspects of the present disclosure generally relate to wireless communication. In some aspects, a receiver may receive a set of radio link control (RLC) packets. The receiver may transmit an RLC status report that includes a first sequence number of an RLC packet of the set of RLC packets, the first sequence number indicating that all RLC packets, of the set of RLC packets, having sequence numbers less than the first sequence number were successfully received by the receiver. Numerous other aspects are described.

### FIELD OF THE DISCLOSURE

Aspects of the present disclosure generally relate to wireless communication and specifically relate to techniques, apparatuses, and methods for an acknowledgement (ACK) status report.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, an apparatus for wireless communication at a receiver includes one or more memories; and one or more processors, coupled to the one or more memories, configured to cause the receiver to: receive a set of radio link control (RLC) packets; and transmit an RLC status report that includes a first sequence number of an RLC packet of the set of RLC packets, the first sequence number indicating that all RLC packets, of the set of RLC packets, having sequence numbers less than the first sequence number were successfully received by the receiver.

In some aspects, an apparatus for wireless communication at a transmitter includes one or more memories; and one or more processors, coupled to the one or more memories, configured to cause the transmitter to: transmit a set of RLC packets; and receive an RLC status report that includes first a sequence number of an RLC packet of the set of RLC packets, the first sequence number indicating that all RLC packets, of the set of RLC packets, having sequence numbers less than the first sequence number were successfully received by a receiver.

In some aspects, a method of wireless communication performed by a receiver includes receiving a set of RLC packets; and transmitting an RLC status report that includes a first sequence number of an RLC packet of the set of RLC packets, the first sequence number indicating that all RLC packets, of the set of RLC packets, having sequence numbers less than the first sequence number were successfully received by the receiver.

In some aspects, a method of wireless communication performed by a transmitter includes transmitting a set of RLC packets; and receiving an RLC status report that includes a first sequence number of an RLC packet of the set of RLC packets, the first sequence number indicating that all RLC packets, of the set of RLC packets, having sequence numbers less than the first sequence number were successfully received by a receiver.

In some aspects, a non-transitory computer-readable medium storing a set of instructions for wireless communication includes one or more instructions that, when executed by one or more processors of a receiver, cause the receiver to: receive a set of RLC packets; and transmit an RLC status report that includes a first sequence number of an RLC packet of the set of RLC packets, the first sequence number indicating that all RLC packets, of the set of RLC packets, having sequence numbers less than the first sequence number were successfully received by the receiver.

In some aspects, a non-transitory computer-readable medium storing a set of instructions for wireless communication includes one or more instructions that, when executed by one or more processors of a transmitter, cause the transmitter to: transmit a set of RLC packets; and receive an RLC status report that includes a first sequence number of an RLC packet of the set of RLC packets, the first sequence number indicating that all RLC packets, of the set of RLC packets, having sequence numbers less than the first sequence number were successfully received by a receiver.

In some aspects, an apparatus for wireless communication includes means for receiving a set of RLC packets; and means for transmitting an RLC status report that includes a first sequence number of an RLC packet of the set of RLC packets, the first sequence number indicating that all RLC packets, of the set of RLC packets, having sequence numbers less than the first sequence number were successfully received by the receiver.

In some aspects, an apparatus for wireless communication includes means for transmitting a set of RLC packets; and means for receiving an RLC status report that includes a first sequence number of an RLC packet of the set of RLC packets, the first sequence number indicating that all RLC packets, of the set of RLC packets, having sequence numbers less than the first sequence number were successfully received by a receiver.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless communication network, in accordance with the present disclosure.

FIG. 3 is a diagram illustrating an example disaggregated base station architecture, in accordance with the present disclosure.

FIG. 4 is a diagram illustrating an example associated with identifying unsuccessful terminations of HARQ processes, in accordance with the present disclosure.

FIG. 5 is a diagram illustrating an example associated with lower-layer feedback reporting, in accordance with the present disclosure.

FIG. 6 is a diagram of an example associated with acknowledgement (ACK) status reporting, in accordance with the present disclosure.

FIG. 7 is a diagram illustrating an example associated with ACK status reporting, in accordance with the present disclosure.

FIG. 8 is a diagram illustrating an example process performed, for example, at a receiver or an apparatus of a receiver, in accordance with the present disclosure.

FIG. 9 is a diagram illustrating an example process performed, for example, at a transmitter or an apparatus of a transmitter, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some wireless communication networks, devices (e.g., a user equipment (UE) and/or a network node) may perform a hybrid automatic repeat request (HARQ) process to improve reliability of communications exchanged between the devices. For example, a transmitting (Tx) device (e.g., a transmitter, a Tx UE, a Tx network node) may transmit a transport block (e.g., data) to a receiving (Rx) device (e.g., a receiver, an Rx UE, an Rx network node), and the Rx device may attempt to decode the data. While each of the Rx device and the Tx device may be referred to as either a receiving and/or a transmitting device in reference to the relative role each device performs in the communication of data, neither of the Rx device and/or the Tx device, as described herein, are limited to receiving and/or transmitting respectively. For example, the Rx device may receive data and may transmit and/or receive one or more other messages. Similarly, the Tx device may receive data and may transmit and/or receive one or more other messages. In examples where the Rx device successfully decodes the data of the transport block, the Rx device may transmit a HARQ acknowledgement (ACK) message to the Tx device. In some examples, successfully decoding data may be referred to herein as successfully receiving the data. Additionally, or alternatively, in examples where the Rx device fails to successfully decode the data, the Rx device may transmit a HARQ negative ACK (NACK) message to the Tx device. In response to receiving a HARQ NACK message from the Rx device, the Tx device may perform a retransmission associated with the transport block. For example, the Tx device may retransmit a portion of the transport block (for example, corresponding to the portion of the transport block that the Rx device was unable to successfully decode). Additionally or alternatively, the Tx device may retransmit the transport block using a same or different redundancy version (for example, using the same or a different set of coded bits associated with the transport block), which may enable the Rx device to perform soft combining, chase combining, and/or incremental redundancy combining. For example, upon receiving the retransmission from the Tx device, the Rx device may attempt to decode the transport block using a combination of the data received in the initial transmission of the transport block and the data received in the retransmission.

In some cases, the Tx device may continue to send retransmissions associated with the transport block until the Tx device receives a HARQ ACK message from the Rx device (for example, indicating that the Rx device successfully decoded the transport block) or until a maximum quantity of retransmissions is reached. In response to receiving the HARQ ACK message from the Rx device or if the maximum quantity of retransmissions is reached, the Tx device may terminate the HARQ process. To terminate the HARQ process, the Tx device may discard data associated with the transport block (for example, from a buffer that is maintained prior to the termination of the HARQ process). In some other cases, the Tx device may terminate the HARQ process without receiving a HARQ ACK message from the Rx device. For example, the Tx device may terminate the HARQ process after a quantity of retransmissions performed by the Tx device satisfies (for example, is greater than or equal to) a quantity threshold associated with a quantity of retransmissions.

In some wireless communication networks, the devices (e.g., Rx device and/or Tx device) may additionally support certain radio link control (RLC) processes to improve reliability of communications between devices. The RLC processes may correspond to processes and communications performed at an RLC layer of the devices. The Tx device may transmit at least one packet (e.g., data packet, service data unit (SDU), packet data unit (PDU)). In some cases, the Rx device may detect “holes” (for example, may detect one or more RLC SDU segments that the Rx device has failed to decode). For example, the Rx device may detect holes based on a sequence number associated with the RLC SDU segments, segmentation information associated with the RLC SDU segments, and/or a segment offset associated with the RLC SDU segments.

In response to detecting or failing to detect holes associated with the RLC, the Rx device may transmit an RLC NACK and/or an RLC ACK, respectively. In some cases, the Rx device transmitting an RLC NACK may trigger the Tx device to retransmit one or more segments of the RLC SDU. Additionally, the Rx device transmitting an RLC ACK may trigger the Tx device to release a buffer (for example, an upper layer buffer) associated with the RLC SDU. This functionality requires the Tx device to have a memory commensurate in size with that of the packet being communicated because the Tx device may store the communication in the buffer until it is confirmed that the communication was successfully received (e.g., decoded) by the Rx device. Confirming the success of each communication at the RLC layer, however, may be slow, which may cause the Tx device to keep the packet in the buffer for a relatively long period of time, thereby consuming memory resources of the Tx device.

For example, the Tx device may retain the RLC SDU (or, for example, a different type of RLC packet) in the Tx buffer until an ACK is received. In some examples, the Rx device may transmit a NACK-specific RLC status report for reporting which packets were unsuccessfully decoded. When the RLC status report is triggered, a NACK may be sent for RLC SDUs (e.g., SDUs having sequence numbers greater than or equal to a sequence number of a first pending (e.g., not yet decoded and/or unsuccessfully decoded) SDU indicated by the information element “RX_Highest_Status”) which may indicate the RLC SDUs that are not queued for HARQ retransmission (e.g., not pending, successfully received, and/or the HARQ process is terminated without successful reception). As a result, feedback may not be communicated for pending segments. Further, when the RLC status report is requested by the Tx device (e.g., as is in polling), the Rx device may wait to transmit the RLC status report until the sequence number of the first pending SDU (e.g., “RX_Highest_Status”) is larger than the RLC SDU that includes the corresponding polling bit which may result in a delay in triggering feedback, which may cause unnecessary delay.

The NACK-specific report may include an ACK field (e.g., ACK_SN) that indicates the sequence number of the next undecoded (e.g., pending) RLC SDU which may not be reported as missing in the RLC status report. For example, when the transmitting side of an acknowledged mode RLC entity (e.g., Tx device) receives the RLC status report, the Tx device may interpret that all RLC SDUs up to, and not including the RLC SDU having the sequence number of the next undecoded RLC SDU, have been received by a peer acknowledged mode RLC entity (e.g., Rx device) (e.g., excluding RLC SDUs (or portions of RLC SDUs) indicated in the RLC status report by a NACK field (e.g., NACK_SN)). The NACK-specific report may include a first field (e.g., E1) that indicates whether the report includes a NACK field (e.g., NACK_SN), and a set of associated indications (e.g., E1, E2, E3) corresponding to each unsuccessfully decoded RLC SDU. The NACK field indicates the sequence number of the RLC SDU (or, for example, RLC SDU segment) that has been detected as lost and/or unsuccessfully decoded. The E2 field indicates whether the MAC/PHY NACK report includes a set of segmentation offset indications (e.g., SOstart and/or SOend). The E3 field indicates whether the MAC/PHY NACK report includes information related to a continuous sequence of RLC SDUs that have not been received and/or successfully decoded. For example, the E3 field may indicate whether the MAC/PHY NACK report includes a NACK range field (e.g., NACK_range) indicating a quantity of consecutively unsuccessfully decoded RLC SDUs starting from and including the RLC SDU corresponding to the NACK field (e.g., NACK_SN).

Various aspects relate generally to ACK status reporting for RLC SDUs and/or RLC SDU segments. Some aspects more specifically relate to ACK-specific status reports (e.g., ACK-only reports) in a lower-layer assisted RLC acknowledged mode for reporting successfully received RLC SDUs. In some aspects, lower-layer protocols of the Rx device may detect and/or report unsuccessful HARQ termination events for ARQ retransmission. As a result, the Rx device may refrain from reporting NACK via the RLC layer and/or may refrain from reporting NACK based on detecting “holes” in the sequence numbers of received RLC SDUs and/or RLC SDU segments. In such aspects, sequence number-based status reporting (e.g., at the RLC layer) may support ACK-specific reporting while NACK-specific reporting may be supported by lower-layer protocols (e.g., may be performed separately and may be supported by lower-layer assisted unsuccessful HARQ termination event reporting). In some aspects, a Tx device may transmit, and an Rx device may receive, a set of RLC packets (e.g., RLC SDUs, RLC PDUs, data packets). The Rx device may transmit, and the Tx device may receive, an RLC status report based on communicating the set of RLC packets. In some aspects, the RLC status report may include a first sequence number of an RLC packet of the set of RLC packets. For example, the first sequence number may indicate that all RLC packets (e.g., of the set of RLC packets received by the Rx device) having sequence numbers less than the first sequence number were successfully received by the Rx device.

Further, the RLC status report may include a second sequence number of a second RLC packet of the set of RLC packets. The second sequence number may indicate that at least a segment of the second RLC packet (e.g., having the second sequence number) was successfully received. In some aspects, the second sequence number may be greater than the first sequence number. Additionally or alternatively, the first sequence number and the second sequence number may be inconsecutive. In some aspects, the Rx device may receive, and the Tx device may transmit, at least one RLC packet including one or more polling bits that indicate a requested type of RLC status report. In such aspects, the transmission of the RLC status report may be in response to and/or otherwise based at least in part on receiving the polling bit.

Particular aspects of the subject matter described in this disclosure can be implemented to realize one or more of the following potential advantages. In some aspects, by the Rx device transmitting, and the Tx device receiving, the RLC status report based on communicating the set of RLC packets, the described techniques can be used to provide ACK-specific feedback for RLC packets that were successfully received such that the Tx device may discard corresponding packets from the Tx buffer. For example, the Tx device may refrain from storing copies of RLC packets that were successfully received thereby increasing available memory resources of the Tx device. In some aspects, by the RLC status report including the first sequence number that indicates that all RLC packets (e.g., of the set of RLC packets received by the Rx device) having sequence numbers less than (or, for example, less than or equal to) the first sequence number were successfully received by the Rx device, the described techniques can be used to reduce overhead associated with an RLC status report that would otherwise provide an ACK indication for each successfully received RLC packet. Additionally, providing an ACK-specific report including the first sequence number may not imply whether RLC packets having sequence numbers greater than the first sequence number were successfully received and/or decoded, thus increasing a flexibility of the RLC status report and enabling the Rx device to include ACK information, in the RLC status report, for inconsecutively received RLC packets even when holes occur.

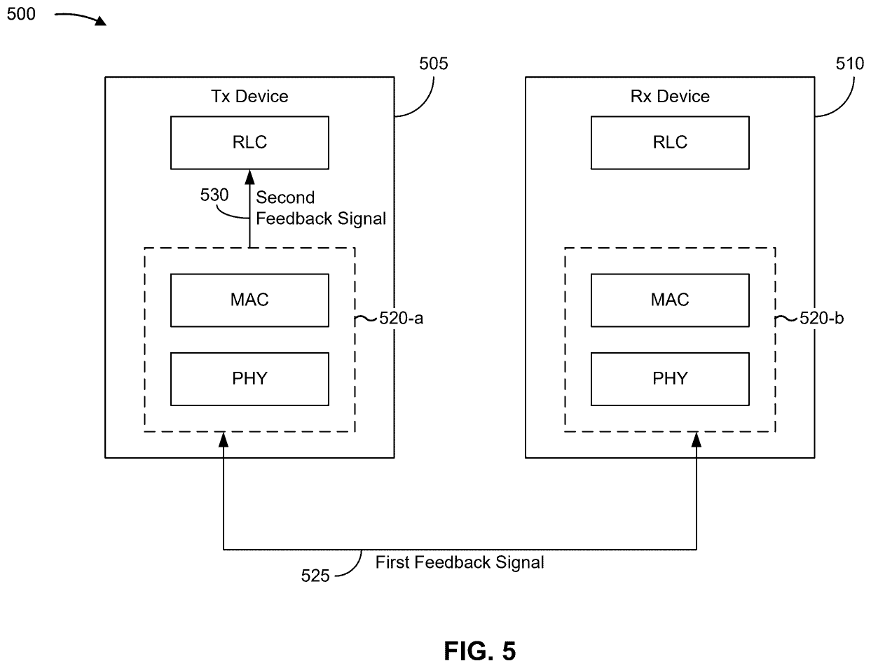

In some aspects, by the RLC status report including the second sequence number indicating that at least a segment of the second RLC packet (e.g., having the second sequence number) was successfully received, ACK feedback may be communicated for RLC packets that are successfully received but are not consecutive (e.g., have consecutive sequence numbers) with other successfully received (e.g., decoded) packets and/or packets that were partially received and/or decoded. Providing ACK feedback for out-or-order and/or partially received packets instead of a NACK for all SDUs having sequence numbers greater than or equal to a sequence number of a first pending SDU may avoid retransmission of a packet that was successfully received after the first pending packet. Additionally, or alternatively, by indicating a requested type of RLC status report, the described techniques may support ACK-specific reporting alongside ACK/NACK reporting thereby increasing feedback reporting flexibility. Further, by the Rx device transmitting the RLC status report for the set of RLC packets based on receiving the polling bit, the described techniques may avoid the Rx device waiting to transmit the RLC status report until the sequence number of the first pending RLC packet (e.g., RLC SDU) is larger than the RLC packet that includes the corresponding polling bit (e.g., as described elsewhere and with reference to FIG. 5), which may decrease a latency associated with NACK-specific reporting.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

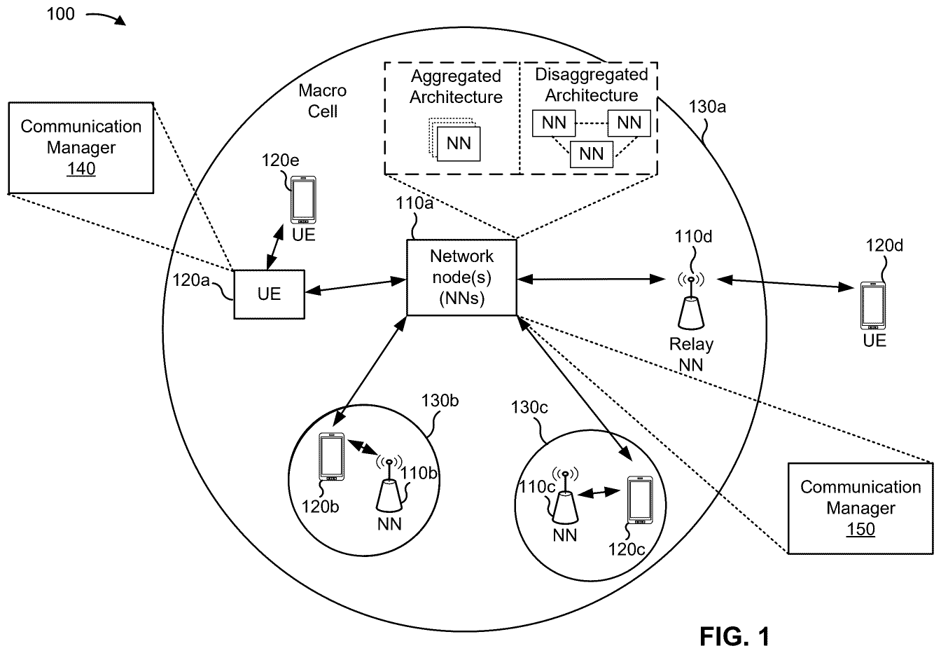

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 May implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of an RLC layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, cMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an uplink (UL) communication to a network node 110, which then transmits the data to the UE 120e in a downlink (DL) communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a receiver (e.g., a receiving UE 120, and/or a receiving network node 110) may include a communication manager 140 and/or a communication manager 150. As described in more detail elsewhere herein, the communication manager 140 and/or the communication manager 150 may receive a set of RLC packets; and transmit an RLC status report that includes a first sequence number of an RLC packet of the set of RLC packets, the first sequence number indicating that all RLC packets, of the set of RLC packets, having sequence numbers less than the first sequence number were successfully received by the receiver. Additionally, or alternatively, the communication manager 140 and/or the communication manager 150 of the receiver may perform one or more other operations described herein.

In some aspects, a transmitter (e.g., a transmitting UE 120, and/or a transmitting network node 110) may include the communication manager 140 and/or the communication manager 150. As described in more detail elsewhere herein, the communication manager 140 and/or the communication manager 150 may transmit a set of RLC packets; and receive an RLC status report that includes a first sequence number of an RLC packet of the set of RLC packets, the first sequence number indicating that all RLC packets, of the set of RLC packets, having sequence numbers less than the first sequence number were successfully received by a receiver. Additionally, or alternatively, the communication manager 140 and/or the communication manager 150 of the transmitter may perform one or more other operations described herein.

As indicated above, FIG. 1 is provided as an example. Other examples may differ from what is described with regard to FIG. 1.

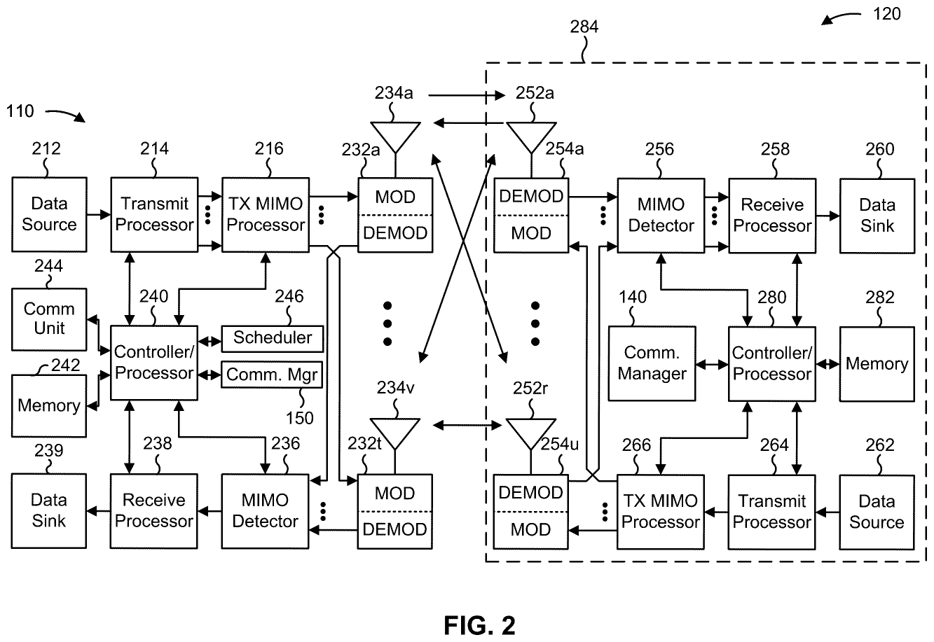

FIG. 2 is a diagram illustrating an example network node 110 in communication with an example UE 120 in a wireless communication network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward an Rx device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

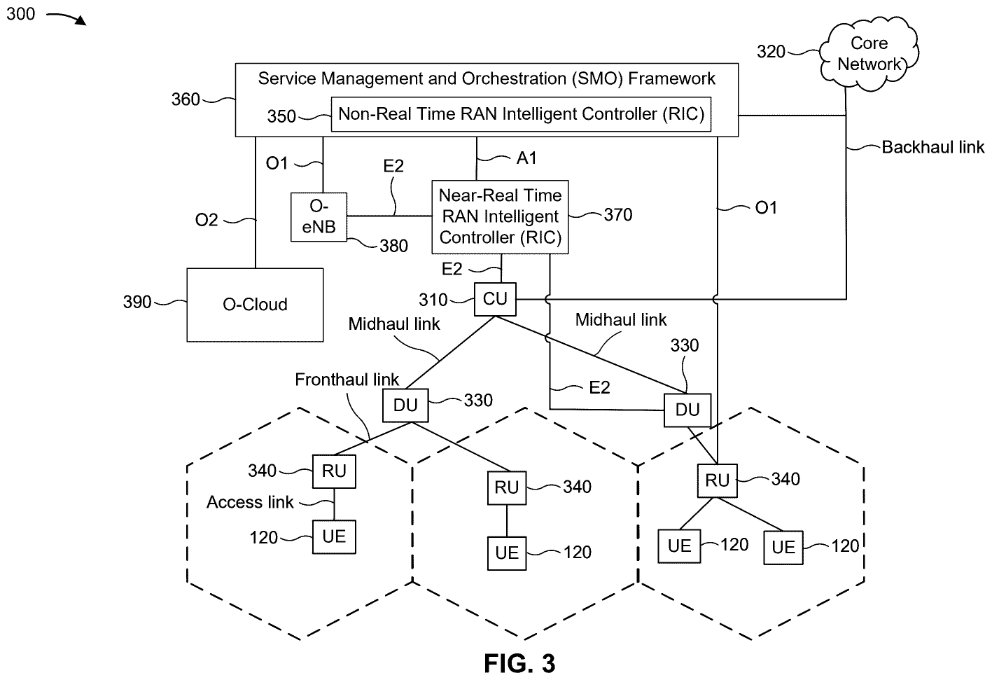

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-cNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

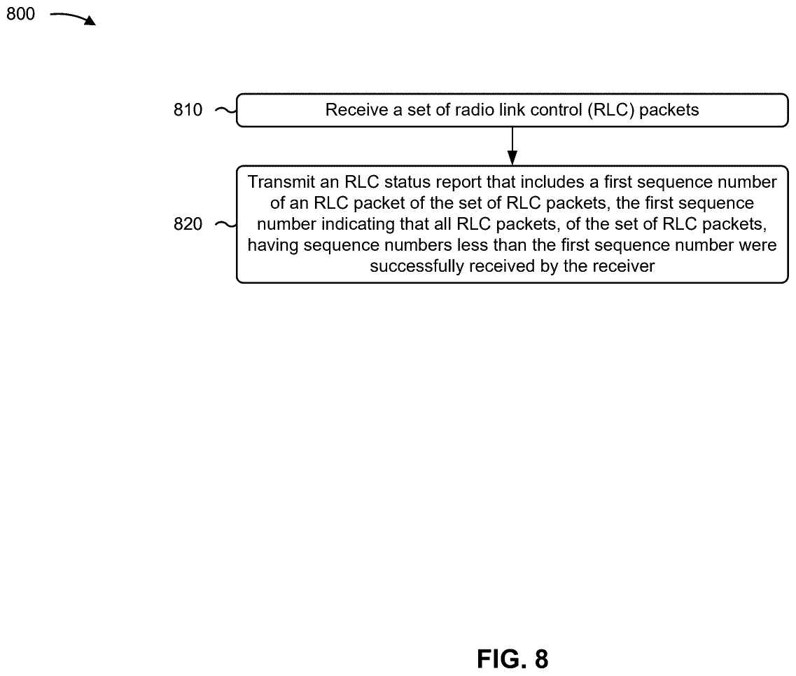

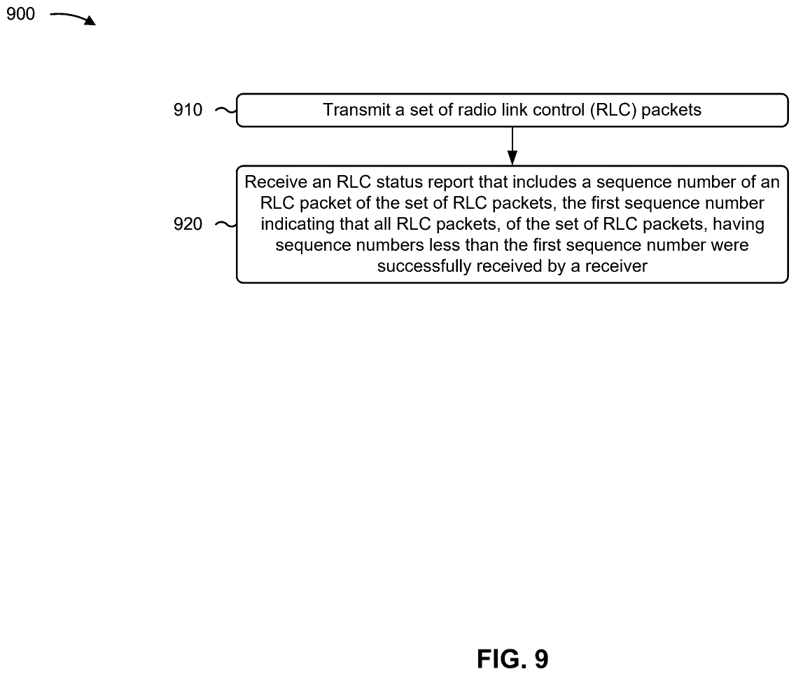

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with an ACK status report, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 800 of FIG. 8, process 900 of FIG. 9, or other processes as described herein (alone or in conjunction with one or more other processors). In some aspects, the transmitter described herein is the base station 110, is included in the base station 110, or includes one or more components of the base station 110 shown in FIG. 2. In some other aspects, the transmitter described herein is the UE 120, is included in the UE 120, or includes one or more components of the UE 120 shown in FIG. 2. In some aspects, the receiver described herein is the UE 120, is included in the UE 120, or includes one or more components of the UE 120 shown in FIG. 2. In some other aspects, the receiver described herein is the base station 110, is included in the base station 110, or includes one or more components of the base station 110 shown in FIG. 2. The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

In some aspects, the receiver includes means for receiving a set of RLC packets; and/or means for transmitting an RLC status report that includes a first sequence number of an RLC packet of the set of RLC packets, the first sequence number indicating that all RLC packets, of the set of RLC packets, having sequence numbers less than the first sequence number were successfully received by the receiver. In some aspects, the means for the receiver to perform operations described herein may include, for example, one or more of communication manager 140, antenna 252, modem 254, MIMO detector 256, receive processor 258, transmit processor 264, TX MIMO processor 266, controller/processor 280, or memory 282. In some other aspects, the means for the receiver to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

In some aspects, the transmitter includes means for transmitting a set of RLC packets; and/or means for receiving an RLC status report that includes a first sequence number of an RLC packet of the set of RLC packets, the first sequence number indicating that all RLC packets, of the set of RLC packets, having sequence numbers less than the first sequence number were successfully received by a receiver. In some aspects, the means for the transmitter to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246. In some other aspects, the means for the transmitter to perform operations described herein may include, for example, one or more of communication manager 140, antenna 252, modem 254, MIMO detector 256, receive processor 258, transmit processor 264, TX MIMO processor 266, controller/processor 280, or memory 282.

As indicated above, FIG. 3 is provided as an example. Other examples may differ from what is described with regard to FIG. 3.

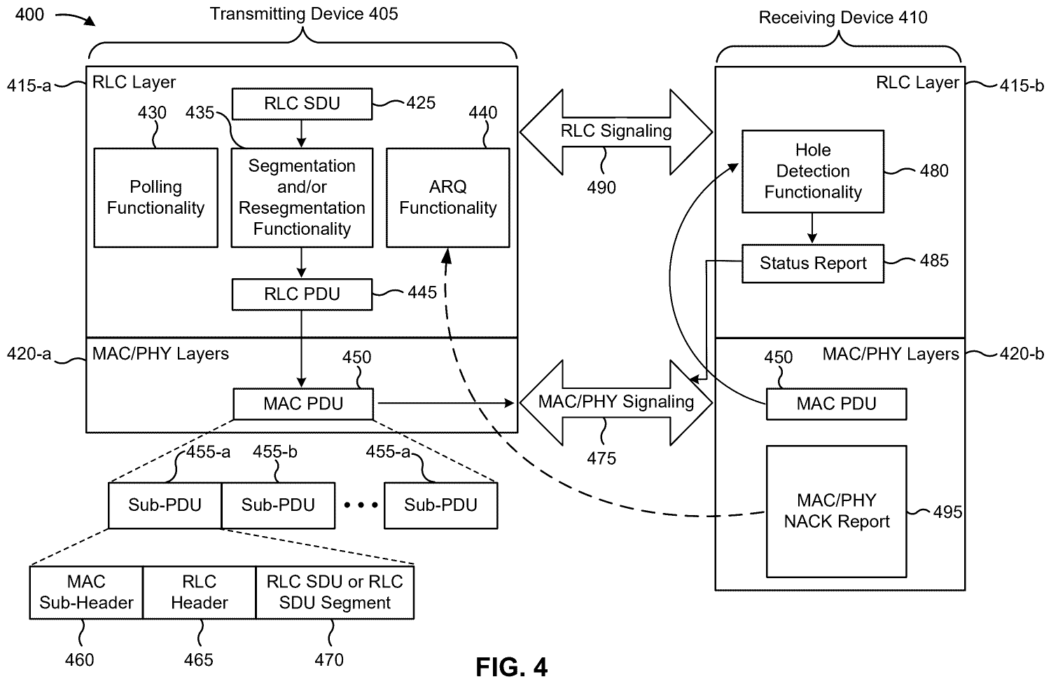

FIG. 4 is a diagram illustrating an example 400 associated with identifying unsuccessful terminations of HARQ processes, in accordance with the present disclosure. As shown in FIG. 4, a Tx device 405 and an Rx device 410 may communicate with one another. For example, the Tx device 405 may transmit, to the Rx device 410, a MAC PDU 450.

In some cases, the Tx device 405 may correspond to a network node 110, the Rx device 410 may correspond to a UE 120, and the Tx device 405 may transmit communications to the Rx device 410 via a downlink. In some other cases, the Tx device 405 may correspond to a UE 120, the Rx device 410 may correspond to a network node 110, and the Tx device 405 may transmit communications to the Rx device 410 via an uplink.

Both the Tx device 405 and the Rx device 410 may include an RLC layer 415 and MAC/PHY layers 420 (for example, including a MAC layer, a PHY layer, or both a MAC layer and a PHY layer). Although not illustrated, the Tx device 405 and the Rx device 410 may also include additional layers, such as PDCP layers, RRC layers, and/or SDAP layers. In the example 400, the RLC 415-a of the Tx device 405 and the RLC layer 415-b of the Rx device 410 may exchange RLC signaling 490. Additionally, the MAC/PHY layers 420-a of the Tx device 405 and the MAC/PHY layers 420-b of the Rx device 410 may exchange MAC/PHY signaling 475.

In the example 400, the RLC layer 415-a of the Tx device 405 may receive the RLC SDU 425 from a PDCP layer of the Tx device 405. The RLC layers 415 (for example, 415-a and 415-b) may have multiple different modes. In particular, the Tx device 405 and the Rx device 410 may operate the RLC layers 415 in accordance with a transparent mode, an unacknowledged mode, or an acknowledged mode. In an example where the RLC layer 415-a is operating in accordance with the transparent mode, the Rx device 410 may pass the RLC SDU 425 through the RLC layer 415-a (for example, from the PDCP layer to the MAC layer of the Tx device 405) as an RLC PDU 445 without additional processing by the RLC layer 415-a. In another example where the RLC layer 415-a is operating in accordance with the unacknowledged mode, the Tx device 405 may perform segmentation functionality (for example, of the segmentation and/or resegmentation functionality 435 illustrated in example 400), but may not perform the automatic repeat request (ARQ) functionality 440. In another example where the RLC layer 415-a is operating in accordance with the acknowledged mode, the Tx device 405 may perform the segmentation and/or resegmentation functionality 435 and the ARQ functionality 440.

When operating the RLC layer 415-a in accordance with the ACK mode, the Tx device 405 may perform the segmentation and/or resegmentation functionality 435 to fit the RLC SDU 425 into available resources (for example, for transmission). For example, the Tx device 405 may segment the RLC SDU 425 to generate multiple RLC SDU segments. The Tx device 405 may perform re-segmentation functionalities (for example, of the segmentation and/or resegmentation functionality 435) to support the ARQ functionality 440, where an available payload size may change.

The RLC layer 415-a of the Tx device 405 may generate the RLC PDU 445, which may include the RLC SDU 425. In some cases, the RLC PDU 445 may include one or multiple RLC SDUs 425 or one or multiple RLC SDU segments (for example, generated by the segmentation functionality of the segmentation and/or resegmentation functionality 435) associated with the RLC SDU 425. Each RLC SDU segment in the RLC PDU 445 may include a header that includes a sequence number associated with the RLC SDU segment. Then, the RLC layer 415-a may provide the RLC PDU 445 to the MAC/PHY layers 420-a of the Tx device, and the MAC/PHY layers 420-a may receive the MAC PDU 450.

The MAC PDU 450 may correspond to a transport block (for example, transmitted from the Tx device 405 to the Rx device via the MAC/PHY signaling 475). The MAC PDU 450 may include one or multiple sub-PDUs 455 (for example, MAC SDUs). Each sub-PDU 455 may include a MAC sub-header 460, an RLC header 465, and an RLC SDU or RLC SDU segment 470. In some examples, the RLC PDU 445 may correspond to the RLC header 465 and the RLC SDU or RLC SDU segment 470 in each sub-PDU 455. The RLC header 465 may include information related to the RLC SDU or RLC SDU segment 470. For example, the RLC header 465 may include a sequence number associated with the RLC SDU or RLC SDU segment 470, segmentation information associated with an RLC SDU segment of the RLC SDU or RLC SDU segments 470, and/or a segment offset associated with an RLC SDU segment of the RLC SDU or RLC SDU segments 470.

The MAC/PHY layers 420-a of the Tx device 405 may transmit, via the MAC/PHY signaling 475, the MAC PDU 450 to the Rx device 410. The MAC/PHY layers 420-b of the Rx device 410 may provide the MAC PDU 450 to the RLC layer 415-b of the Rx device 410. The Rx device 410 may perform a HARQ process associated with the MAC PDU 450. For example, in cases where the Rx device 410 successfully decodes the MAC PDU 450, the Rx device 410 may transmit a HARQ ACK message to the Tx device 405 via the MAC/PHY signaling 475. Additionally, in cases where the Rx device 410 fails to successful decode the MAC PDU 450, the Rx device 410 may transmit a HARQ NACK message to the Tx device 405 via the MAC/PHY signaling 475. In response to receiving a HARQ NACK message from the Rx device 410, the Tx device 405 may perform a retransmission associated with the MAC PDU 450. For example, the Tx device 405 may retransmit a portion of the MAC PDU 450 (for example, that is selected based on the portion of the MAC PDU 450 that the Rx device 410 was unable to successfully decode). Upon receiving the retransmission from the Tx device 405, the Rx device 410 may attempt to decode the MAC PDU 450 using a combination of the data received in the initial transmission of the transport block and the data received in the retransmission.

In some cases, the Tx device 405 may continue to send retransmissions associated with the MAC PDU 450 until the Tx device 405 receives a HARQ ACK message from the Rx device 410 (for example, indicating that the Rx device successfully decodes the MAC PDU 450). In response to receiving the HARQ ACK message from the Rx device 410, the Tx device 405 may terminate the HARQ process. In some other cases, the Tx device 405 may terminate the HARQ process without receiving a HARQ ACK message from the Rx device 410. For example, the Tx device 405 may terminate the HARQ process after a quantity of retransmissions performed by the Tx device 405 satisfies (for example, is equal to or greater than) a quantity threshold associated with a quantity of retransmissions.

In cases where the RLC layer 415-b of the Rx device is operating in accordance with the ACK mode, the Rx device 410 may additionally perform an ARQ process. For example, the RLC layer 415-b of the Rx device 410 may support the ARQ functionality 440. Here, the RLC layer 415-b of the Rx device 410 may have a hole detection functionality 480, which may enable the Rx device 410 to detect holes (for example, to detect one or more RLC SDU segments 470 in a MAC PDU 450 that the Rx device 410 has failed to decode). In some cases, the Rx device 410 may detect holes based on a sequence number associated with the RLC SDU or RLC SDU segments 470 (for example, included in the RLC header 465), segmentation information associated with the RLC SDU or RLC SDU segments 470 (for example, included in the RLC header 465, included in the MAC sub-header 460), and/or a segment offset associated with the RLC SDU or RLC SDU segments 470 (for example, included in the RLC header 465, included in the MAC sub-header 460). In some instances, the Rx device 410 may detect the holes with or without assistance from a lower layer (for example, MAC/PHY layers 420-b of the Rx device 410).

The Rx device 410 may detect holes associated with a transmission of the MAC PDU 450 based on a timer (for example, a t-Reassembly timer). For example, the Rx device 410 may identify one or more missing RLC SDUs or RLC SDU segments 470 based on the sequence numbers associated with RLC SDUs or RLC SDU segments 470 that have been successfully received and decoded. The Rx device 410 may initiate the timer in response to identifying that one or more RLC SDUs or RLC SDU segments 470 are missing. If, prior to an expiration of the timer, the Rx device 410 does successfully receive and decode the one or more missing RLC SDUs or RLC SDU segments 470 (for example, as part of a HARQ process associated with the MAC PDU 450), the Rx device 410 may reset the timer. Additionally, if the Rx device 410 does not successfully receive and decode the one or more missing RLC SDUs or RLC SDU segments 470 prior to the expiration of the timer, the Rx device 410 may generate and transmit the status report 485 to the Tx device 405.

In one example, the Rx device may detect holes as part of the RLC process in instances of a HARQ NACK to HARQ ACK error. In this example, the Rx device 410 may transmit a HARQ NACK to the Tx device 405, and the Tx device 405 may interpret the HARQ NACK as a HARQ ACK. As a result, the Tx device 405 may terminate the HARQ process (for example, may stop HARQ transmissions and/or retransmissions for the MAC PDU 450).

In the example 400, the Rx device 410 may detect NACK to ACK errors prior to an expiration of the timer associated with the hole detection functionality 480 (for example, prior to the expiration of the t-Reassembly timer). In particular, the Rx device 410 may detect the NACK to ACK errors based on detecting an unsuccessful termination of a HARQ process (for example, due to a NACK to ACK error) associated with the MAC PDU 450. Then, the Rx device 410 may report the unsuccessful termination of the HARQ process associated with the MAC PDU 450 to the Tx device 405. For example, the Rx device 410 may detect and report instances where a MAC PDU 450 associated with a HARQ process identifier is not decoded and the Rx device 410 receives another MAC PDU 450 associated with the same HARQ process identifier. Additionally, the Rx device 410 may detect and report instances where a MAC PDU 450 associated with a HARQ identifier is associated with an new data indicator value that is different from an expected value (for example, which may correspond to instances where the Rx device 410 previously failed to receive or decode control information scheduling another MAC PDU 450 associated with the same HARQ identifier and the other MAC PDU 450).

The status report 485 may be associated with a timer (for example, a t-StatusProhibit timer). Here, the Rx device 410 may refrain from transmitting the status report 485 until the timer expires. In some cases, the Rx device 410 waiting until the timer expires to transmit the status report 485 may decrease a periodicity associated with the Rx device 410 sending status reports 485. That is, after the Rx device 410 sends a status report 485, the Rx device 410 may reset and start (for example, initiate) the timer and may be unable to send another status report 485 until an expiration of the timer. The status report 485 may include RLC ACK and/or RLC NACK for certain sequence numbers (for example, associated with the MAC PDU 450).

The Rx device 410 may transmit a status report 485 in response to a polling request from the Tx device 405. For example, the Tx device 405 may include the polling functionality 430 at the RLC layer 415-a. In this example, the Tx device may transmit, to the Rx device 410 (for example, via the RLC signaling 490, via the MAC/PHY signaling 475) a polling request triggering the Rx device 410 to transmit the status report 485 to the Tx device 405. The Tx device 405 may transmit the polling request based on a quantity of MAC PDUs 450 transmitted to the Rx device 410. For example, the Tx device 405 may transmit the polling request after transmitting a certain quantity of MAC PDUs 450 (for example, as indicated by a variable such as a pollPDU variable). In another case, the Tx device 405 may transmit the polling request based on a quantity of bytes transmitted (for example, via one or more MAC PDUs 450) to the Rx device 410. For example, the Tx device 405 may transmit the polling request after transmitting a certain quantity of bytes (for example, as indicated by a variable such as a pollByte variable).

The Rx device 410 may transmit the status report 485 via the MAC/PHY signaling 475 or, in some other cases, via the RLC signaling 490. In response to receiving the status report 485, the Tx device 405 may perform an ARQ process (for example, using the ARQ functionality 440 of the RLC layer 415-a). For example, the Tx device 405 may retransmit any of the RLC SDU or RLC SDU segments 470 that correspond to a sequence number indicated as not successfully received and decoded in the status report 485. In some cases, the Tx device 405 may continue transmitting retransmissions of any RLC SDUs or RLC SDU segments 470 until the Rx device 410 indicates that the RLC SDUs or RLC SDU segments 470 have been successfully received and decoded (for example, via an RLC ACK for the sequence numbers associated with the RLC SDUs or RLC SDU segments 470). Additionally or alternatively, the Tx device 405 may refrain from transmitting a retransmission of an RLC SDU or RLC SDU segment 470 in instances where a quantity of retransmissions associated with that RLC SDU or RLC SDU segment 470 is greater than a threshold (for example, a maxRetxThreshold).

In some examples, the MAC/PHY layers 420-b of the Rx device 410 may have a MAC/PHY NACK report functionality 495, which may enable the Rx device 410 to detect and report unsuccessful HARQ termination events via MAC/PHY signaling 475. The MAC/PHY NACK report is further described with reference to FIG. 5. In some examples, the MAC/PHY NACK report 495 may replace reporting NACK in the status report 485. For example, the Tx device 405 may perform the ARQ functionality 440 based on receiving the MAC/PHY NACK report 495 which may reduce ARQ latency associated with unsuccessful HARQ termination. By communicating the MAC/PHY NACK report 495, the Tx device 405 and the Rx device 410 may communicate feedback more quickly than using only the status report 485 which may also reduce the buffer size of the Rx device 410 by communicating retransmitted data sooner upon a failed or incomplete transmission.

FIG. 5 is a diagram illustrating an example 500 associated with lower-layer feedback reporting, in accordance with the present disclosure. As shown in FIG. 5, example 500 includes communication between a Tx device 505 and an Rx device 510. In some aspects, Tx device 505 and the Rx device 510 may be included in a wireless communication network, such as wireless communication network 100. The Tx device 505 and the Rx device 510 may communicate via a wireless access link, which may include an uplink and a downlink. For example, for downlink communications, the Tx device 505 may be a network node 110, and the Rx device 510 may be a UE 120. For uplink communications, the Tx device 505 may be a UE 120, and the Rx device 510 may be a network node 110.

The Tx device 505 and the Rx device 510 may each include a PHY layer, a MAC layer (e.g., MAC/PHY layers 520-a and 520-b, respectively), and an RLC layer. In some aspects, the Tx device 505 and/or the Rx device 510 may be configured for RLC communication (e.g., communication via the RLC layer) using one or more modes such as a transparent mode, an unacknowledged mode, and an acknowledged mode. In the transparent mode, an RLC SDU may pass through the RLC as an RLC PDU without additional processing. In the unacknowledged mode, the Tx device 505 may perform segmentation (e.g., dividing larger packets into smaller packets) and/or resegmentation (e.g., segmenting an RLC SDU or re-segmenting a segment of an RLC SDU for an ARQ retransmission), and the Rx device 510 may perform re-segmentation (e.g., combining the segmented packets into larger packets). In the acknowledged mode, the Tx device 505 may perform segmentation, re-segmentation, and ARQ retransmissions. For example, in the acknowledged mode, the Tx device 505 may segment a packet (to create RLC SDU segments) so the RLC SDU may fit in an available resources. The Rx device 510 transmit a first feedback signal 525 (e.g., an ACK or NACK (ACK/NACK)) to the Tx device 505.

The first feedback signal 525 may indicate whether each of the RLC SDU segments were received by the Rx device 510. If an RLC SDU segment was received at the Rx device 510, the Rx device 510 may transmit, to the Tx device 505, the first feedback signal 525 with an ACK. When the Tx device 505 receives the ACK, the Tx device 505 may clear an upper layer buffer, which may be used to store the RLC SDU, the RLC SDU segment, and/or a combination thereof, among other examples. If an RLC SDU segment was not received at the Rx device 510, the Rx device 510 may transmit, to the Tx device 505, the first feedback signal 525 with a NACK. When the Tx device 505 receives the NACK, the Tx device 505 may retransmit the RLC SDU or RLC SDU segment associated with the NACK (e.g., the RLC SDU or RLC SDU segment that was not received by the Rx device 510) through ARQ mechanisms.

The RLC SDU or RLC SDU segment may be stored in the buffer of the Tx device 505 until the ACK for the RLC SDU or RLC SDU segment is received from the Rx device 510. Accordingly, buffer size of the Tx device 505 may depend on the data rate and the amount of time for the Rx device 510 to transmit the first feedback signal 525. For in-order delivery at the PDCP layer (which is above the RLC layer) in the RLC acknowledged mode, the Rx device 510 may also buffer the received RLC SDUs or SDU segments when the previous RLC SDUs or SDU segments (with smaller sequence number) have not yet been delivered, which may result in an RLC hole (e.g., a missing RLC SDU or RLC SDU segment).

In some aspects, lower layers (e.g., the PHY layer and/or MAC layer) of the Rx device 510 may be used to expedite the identification of packet loss between the Tx device 505 and the Rx device 510. For example, the Rx device 510 may be configured to determine the success or failure of the receipt of the RLC SDU or RLC SDU segment by having the PHY layer or the MAC layer, rather than the RLC layer, determine the ACK/NACK information from the first feedback signal 525. In such aspects, the first feedback signal 525 may include a MAC/PHY NACK report (e.g., as referred to with reference to FIG. 4).

The lower layers of the Rx device 510 may be able to identify packet loss more quickly than the RLC layer of the Rx device 510 because the lower layers have direct access to the lower layers of the Tx device 505. Accordingly, at the lower layers, the packet loss can be determined directly using the ACK/NACK information rather than having the RLC layer deduce packet loss by analyzing multiple packets (e.g., RLC SDUs or RLC SDU segments).

In some aspects, the Tx device 505 may be configured to maintain an association between a TB, such as a MAC PDU, and one or more of the RLC SDUs or RLC SDU segments. If the lower layers of the Tx device 505 abandon a transmission of a TB, the lower layers of the Tx device 505 may transmit a NACK for each RLC SDU or RLC SDU segment associated with the TB to the RLC of the Tx device 505 for ARQ (e.g., retransmission of the RLC SDU or RLC SDU segment to the Rx device 510). In such examples, the Tx device 505 may infer which segments of the RLC SDU packet were successfully received and thus an explicit ACK report may not be necessary for performing ARQ.

In some aspects, if the lower layers of the Tx device 505 receive a first feedback signal with a NACK indicating that the TB was not received, the lower layers of the Tx device 505 may be configured to transform the first feedback signal with the NACK to a second feedback signal 530, and transmit the second feedback signal 530 to the RLC layer of the Tx device 505. In some aspects, the Tx device 505 may determine that the TB was not received through an error detection technique such as ACK-to-NACK error detection. In some aspects, the Tx device 505 may determine that the TB was not received through a reliable NACK report from the lower layers of the Rx device 510.

The RLC status report (e.g., as described with reference to status report 485 of FIG. 4) may still be used for reporting ACK. However, RLC ACK status reporting may be based on a polling mechanism of the Tx device 505. For example, the Rx device 510 may transmit a status report (e.g., such as status report 485 of FIG. 4) in response to a polling request from the Tx device 505.

In such examples, the Tx device 505 may retain the RLC SDU in the Tx buffer until an ACK is received. Additionally, when the RLC status report is triggered, a NACK may be sent for RLC SDUs (e.g., SDUs having sequence numbers greater than or equal to a sequence number of a first pending SDU indicated by the information element “RX_Highest_Status”) which may indicate the RLC SDUs not queued for HARQ retransmission (e.g., not pending). As a result, feedback may not be communicated for pending segments. Further, when the RLC status report is requested by the Tx device 505 (e.g., as is in polling), the Rx device 510 may wait until the sequence number of the first pending SDU (e.g., “RX_Highest_Status”) is larger than the RLC SDU that includes the corresponding polling bit which may result in a delay in triggering feedback, which may cause unnecessary delay.

As indicated above, FIG. 5 is provided as an example. Other examples may differ from what is described with respect to FIG. 5.

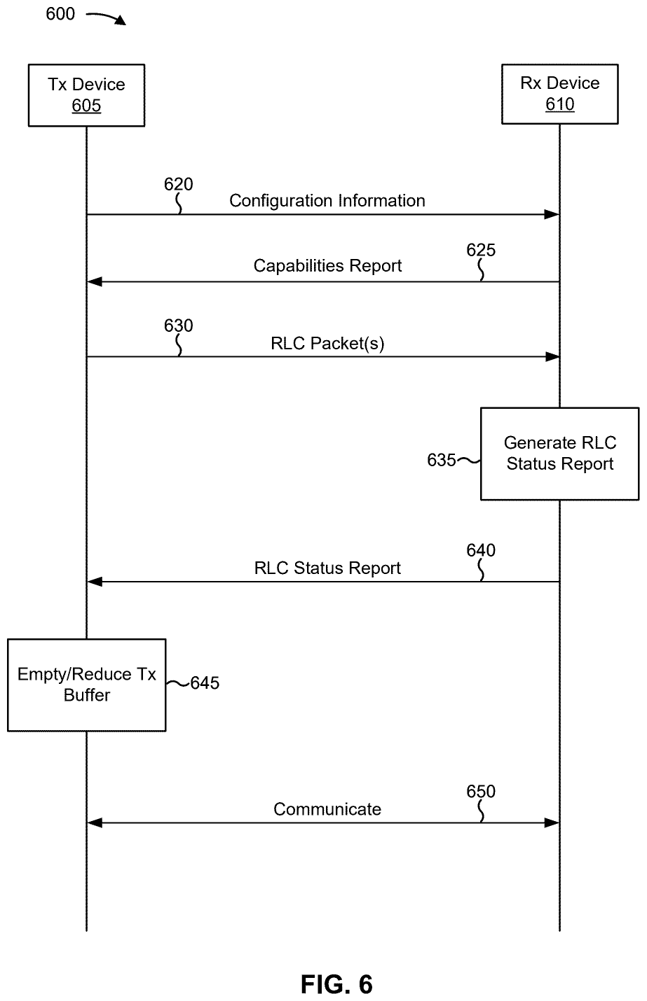

FIG. 6 is a diagram of an example 600 associated with ACK status reporting, in accordance with the present disclosure. As shown in FIG. 6, an Rx device 610 (e.g., receiver, an Rx UE (e.g., a receiving UE 120), an Rx network node (e.g., a receiving network node 110, CU, DU, and/or RU)) may communicate with a Tx device 605 (e.g., transmitter, a Tx UE (e.g., a transmitting UE 120), a Tx network node (e.g., a transmitting network node 110, CU, DU, and/or RU)). In some aspects, the Tx device 605 and the Rx device 610 may be part of a wireless communication network (e.g., wireless communication network 100). The Rx device 610 and the Tx device 605 may have established a wireless connection prior to operations shown in FIG. 6.

As shown by reference number 620, the Tx device 605, and the Rx device 610 may receive, configuration information. In some aspects, the Rx device 610 may receive the configuration information via one or more of system information (e.g., a master information block (MIB) and/or a system information block (SIB), among other examples), RRC signaling, one or more MAC-CEs, and/or DCI, among other examples.

In some aspects, the configuration information may indicate one or more candidate configurations and/or communication parameters. For example, the Rx device and/or the Tx device may be configured, by the configuration information, with an RLC acknowledged mode polling configuration including a timer associated with polling (e.g., t-PollRetransmit), a poll trigger for packets (e.g., pollPDU), and/or a poll trigger for data bytes (e.g., pollByte). For example, the duration of the timer may be configured by the configuration information, and which may be started or restarted when a polling bit is communicated in a packet. The timer may be stopped when an RLC status report is received which may initiate data retransmissions and/or poll retransmission. The poll trigger for packets may trigger an RLC status report for each communicated packet. The poll trigger for bytes may trigger an RLC status report for each communicated byte.

In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC CEs and/or one or more DCI messages, among other examples.

In some aspects, the configuration information may indicate that the Rx device 610 is to periodically transmit an RLC status report. For example, the configuration information may include a periodic schedule for communicating RLC status reports. In some aspects, the configuration may indicate one or more other parameters for communicating RLC status reports. In some aspects, the periodic schedule is configured via RRC signaling.

The Rx device 610 may configure itself based at least in part on the configuration information. In some aspects, the Rx device 610 may be configured to perform one or more operations described herein based at least in part on the configuration information.

As shown by reference number 625, the Rx device 610 may transmit, and the Tx device 605 may receive, a capabilities report. The capabilities report may indicate whether the Rx device 610 supports a feature and/or one or more parameters related to the feature. For example, the capability information may indicate a capability and/or parameter for transmitting one or more RLC status reports. As another example, the capabilities report may indicate a capability and/or parameter for formatting an ACK-specific RLC status report. One or more operations described herein may be based on capability information of the capabilities report. For example, the Rx device 610 may perform a communication in accordance with the capability information, or may receive configuration information that is in accordance with the capability information. In some aspects, the capabilities report may indicate Rx device 610 support for receiving a set of RLC packets and/or transmitting an RLC status report that indicates RLC packets, of the set of RLC packets, that were successfully received (e.g., including packets that were successfully received out-of-sequence).

In some aspects, the configuration information described in connection with reference number 620 and/or the capabilities report described in connection with reference number 625 may include information transmitted via multiple communications. Additionally, or alternatively, the Tx device 605 may transmit the configuration information, or a communication including at least a portion of the configuration information, before and/or after the Rx device 610 transmits the capabilities report. For example, the Tx device 605 may transmit a first portion of the configuration information before the capabilities report, the Rx device 610 may transmit at least a portion of the capabilities report, and the Tx device 605 may transmit a second portion of the configuration information after receiving the capabilities report.

As shown by reference number 630, the Tx device 605 may transmit, and the Rx device 610 may receive, a set of one or more RLC packets. In some aspects, the Tx device 605 may transmit, and the Rx device 610 may receive, at least one RLC packet including a polling bit (e.g., a set of one or more polling bits) that indicates a requested type of RLC status report (e.g., ACK-specific RLC status report, ACK/NACK RLC status report). The Tx device 605 may request an RLC status report from the Rx device 610 by transmitting at least one RLC packet that includes a polling bit, a polling information element, and/or a polling field.

In some aspects, the at least one RLC packet (e.g., including the polling bit) is communicated separately from the set of one or more RLC packets described in connection with reference number 630. In some other aspects, the at least one RLC packet (e.g., including the polling bit) is communicated in the set of one or more RLC packets. For example, at least one RLC packet of the set of one or more RLC packets described in connection with reference number 630 may include a polling bit.

The polling bit may indicate that the Tx device requests an RLC status report and may additionally, or alternatively, indicate a type of the requested RLC status report. For example, the polling bit may indicate a request for an ACK/NACK status report, and/or an ACK status report. In such examples, the polling bit may include two bits. In some examples, the polling bit may be included in the at least one RLC packet but may indicate that an RLC status report is not requested by the Tx device 605.

As shown by reference number 635, the Rx device 610 may generate an RLC status report (e.g., based at least in part on receiving the set of one or more RLC packets described in connection with reference number 630). For example, the Rx device 610 may generate an RLC status report that includes a first sequence number of an RLC packet of the set of RLC packets. The first sequence number (e.g., RX_Next) may indicate that all RLC packets, of the set of RLC packets, having sequence numbers less than the first sequence number were successfully received (e.g., successfully decoded) by the Rx device 610. In some other aspects, the first sequence number (e.g., RX_Next−1) may indicate that all RLC packets (e.g., of the set of RLC packets described in connection with reference number 630) having sequence numbers less than or equal to the first sequence number were successfully received by the Rx device 610.

In some aspects, the Rx device 610 may generate an RLC status report that includes a second sequence number (e.g., OutofOrderAck_SN) of a second RLC packet of the set of RLC packets described in connection with reference number 630. The second sequence number may indicate that at least a segment of the second RLC packet (e.g., having the second sequence number) was successfully received. In some aspects, the second sequence number may be greater than the first sequence number. Additionally or alternatively, the first sequence number and the second sequence number may be inconsecutive. Inconsecutive RLC packets may alternatively be referred to as “out-of-order” and/or “out-of-sequence” RLC packets.

In some aspects, the Rx device 610 may generate an RLC status report that includes a set of indications corresponding to the second sequence number. For example, the set of indications may include an indication of whether the RLC status report includes the second sequence number. For example, the RLC status report may include a field (e.g., F1) indicating whether the second sequence number (e.g., OutofOrderAck_SN) and/or a set of fields associated with the second sequence number (e.g., associated F1/F2/F3 fields) are included in the RLC status report. In such examples, F1 may be different from associated F1. For example, F1 may indicate whether the RLC status report includes an OutofOrderAck_SN and the F1 field associated with OutofOrderAck_SN may indicate whether the RLC status report includes an additional OutofOrderAck_SN (e.g., corresponding to an additional RLC packet).

Additionally, or alternatively, the set of indications may include an indication of a whether the RLC status report includes a third sequence number indicating that a third RLC packet associated with the third sequence number was successfully received. For example, the RLC status report may include a field (e.g., associated F1) indicating whether a next (e.g., additional) next OutofOrderAck_SN is included in the RLC status report. A first F1 field may have a value of 0 if the RLC status report does not include the second sequence number. The first F1 field may have a value of 1 if the RLC status report includes the second sequence number. In such examples, the second F/field (e.g., corresponding to the second sequence number) may be included in the RLC status report. The second F/field may have a value of 0 if the RLC status report does not include at least one additional out-of-order sequence number (e.g., an additional second sequence number). The second F1 field may have a value of 1 if the RLC status report includes at least one additional out-of-order sequence number. In such examples, a third F1 field (e.g., corresponding to the at least one additional out-of-order sequence number) may be included in the RLC status report. For example, in addition to a first F1 field (e.g., indicating whether a first OutofOrderAck_SN is indicated in the RLC status report), for each OutofOrderAck_SN indicated in the RLC status report, the RLC status report may include an associated F1 field indicating whether the corresponding RLC packet is a lastly occurring out-of-order RLC packet (e.g., that was successfully decoded). As an example, if the RLC status report includes the second sequence number and an additional second sequence number, the RLC status report may include three F1 fields: a first F1 field indicating the RLC status report includes the second sequence number (e.g., a first OutofOrderAck_SN), a second F1 field indicating that the RLC status report includes the additional second sequence number (e.g., a second OutofOrderAck_SN), and a third F1 field indicating that the RLC status report does not include a second additional second sequence number (e.g., does not include a third OutofOrderAck_SN).

Additionally, or alternatively, the set of indications may include an indication of whether the RLC status report includes a segmentation offset indication corresponding to the second sequence number. For example, the RLC status report may include a field (e.g., F2) indicating whether a corresponding segmentation offset start indication (e.g., indicating the beginning of a successfully received packet segment), such as SOstart and/or a corresponding segmentation offset end indication (e.g., indicating the end of a successfully received packet segment), such as SOend are included in the RLC status report. For example, the RLC status report may include the segmentation offset indication that indicates that the second RLC packet and/or a third RLC packet within an indicated range of the second RLC packet was partially received. If the field (e.g., F2) indicates that the segmentation offset indication is not included, then the entire RLC packet having the second sequence number (e.g., the packet having OutofOrderAck_SN corresponding to the field, F2) is successfully received. If the field (e.g., F2) indicates that the segmentation offset indication is included, but a different field (e.g., F3) indicates that an ACK range field is not included for the second sequence number, then the corresponding segmentation offset start indication and/or the corresponding segmentation offset end indication indicate that the RLC packet segment within the RLC packet having the second sequence number is successfully received. If the field (e.g., F2) indicates that the segmentation offset indication is included and the different field (e.g., F3) indicates that the ACK range field is also included, the corresponding segmentation offset start indication refers to a start of a segment in the second RLC packet having the second sequence number, and the corresponding segmentation offset end indication refers to the end of a segment in the third RLC packet (e.g., an RLC packet having a sequence number greater than the second sequence number by the indicated range minus one (e.g., OutofOrderAck_SN+ACK range−1)) having a third sequence number.

In such examples, RLC packets having sequence numbers between the second sequence number and the third sequence number (e.g., packets having sequence numbers OutofOrderAck_SN+1, OutofOrderAck_SN+2, . . . , OutofOrderAck_SN+ACK range−2) are fully received. Additionally, a last segment of the second RLC packet (e.g., the last segment of the RLC packet having OutofOrderAck_SN) and a first segment of the RLC packet having the third sequence number (e.g., the first segment of the RLC packet having OutofOrderAck_SN+ACK range−1) are also successfully received. That is, in such examples, a portion of each of the second packet and the third packet may be successfully received.

Additionally, or alternatively, the set of indications may include an indication of whether the RLC status report includes a range indication corresponding to the second sequence number. For example, the RLC status report may include a field (e.g., F3) indicating whether a corresponding ACK range field (e.g., ACK range field (e.g., ACK_range) corresponding to the OutofOrderAck_SN) is included. In such examples, the ACK range may be the number of consecutively received RLC packets starting with and including the corresponding second sequence number (e.g., the corresponding OutofOrderAck_SN). For example, F3 may indicate whether an ACK range corresponding to the second sequence number is included in the RLC status report.

In some aspects, the RLC status report may include a range indication that indicates a quantity of consecutive RLC packets, including the second RLC packet and associated with corresponding sequence numbers greater than or equal to the second sequence number, for which at least a segment of each packet was successfully received. The second RLC packet may be inconsecutive with the RLC packet and the RLC status report may include a range indication, such as “ACK_range” that may indicate how many consecutive packets (e.g., starting with the second RLC packet) of which at least a segment was successfully received.

In some aspects, the RLC status report may include the segmentation offset indicating that the second RLC packet and/or the third RLC packet within the indicated range of the second RLC packet was partially received. In some aspects, the second sequence number may correspond to a highest sequence number for which at least a segment of a corresponding packet was successfully received. For example, the RLC status report may include an ACK for any received RLC packet and/or packet segment even if the corresponding packets are received out-of-order (e.g., inconsecutively) or for an RLC packet corresponding to the highest sequence number received.

In some aspects, the RLC status report may include a field indicating that the RLC status report is an ACK report. For example, the field may include a control packet type field and/or a header that indicates the RLC status report is an ACK report. The RLC status report may include a field, such as a control PDU type (CPT) field that indicates whether the RLC status report includes an ACK/NACK status report and/or an ACK status report. Thus, an ACK-specific RLC status report may be distinguished from an ACK/NACK RLC status report by a field/sub-header in the RLC status report.

As shown by reference number 640, the Rx device 610 may transmit, and the Tx device 610 may receive, the RLC status report. For example, the Rx device 610 may transmit the RLC status report described in connection with reference number 635. In some aspects, transmitting the RLC status report is associated with the polling bit including a request for an ACK status report, and/or an ACK/NACK status report. In some aspects, transmitting the RLC status report described in connection with reference number 640 may include transmitting control signaling including the RLC status report.

In some aspects, the Rx device 610 may transmit RLC signaling, and/or MAC signaling including the RLC report described in connection with reference number 635. For example, the ACK-specific RLC status report may be processed, generated, and/or communicated via one or more functionalities of the RLC layer (e.g., RLC layer 415-b as described with reference to FIG. 4). In such examples, the Rx device may transmit an RLC PDU including the RLC status report. Additionally, or alternatively, the ACK-specific RLC status report may be processed, generated, and/or communicated via one or more functionalities of the MAC layer (e.g., PHY/MAC layers 420-b as described with reference to FIG. 4). In such examples, the Rx device may transmit a MAC-CE including the RLC status report.

In some aspects, the Rx device 610 may transmit, and the Tx device 605 may receive, the RLC status report in accordance with a periodic schedule. For example, the Rx device 610 may periodically transmit the RLC status report according to a configured schedule (e.g., configured by the configuration information described in connection with reference number 620).

As shown by reference number 645, the Tx device 605 may empty and/or reduce a Tx buffer of the Tx device 605. In a first example, the Tx device 605 may empty the Tx buffer such that there is no data being stored in the Tx buffer by deleting and/or discarding one or more RLC packets from the Tx buffer. In a second example, the Tx device 605 may reduce an amount of data stored in the Tx buffer by deleting and/or discarding one or more RLC packets from the Tx buffer.

As shown by reference number 650, the Rx device 610 may communicate with the Tx device 605 (e.g., based at least in part on communicating the RLC status report described in connection with reference number 640 and/or reducing the Tx buffer as described in connection with reference number 645). For example, the Rx device 610 and/or the Tx device 605 may communicate an additional set of RLC packets and/or one or more other data and/or control messages.

Based at least in part on the Rx device 610 transmitting the RLC status report, the Tx device may conserve computing, power, and/or data storage resources that may have otherwise been consumed by storing RLC packets which the Rx device successfully decoded. For example, based at least in part on Tx device 605 reducing the amount of data in the buffer of the Tx device 605, the Tx device 605 and the Rx device 610 may communicate more efficiently with a reduced error rate and decreased latency which may conserve computing, power, network, and/or communication resources that may have otherwise been consumed to detect and/or correct communication errors and store successfully decoded RLC packets.

As indicated above, FIG. 6 is provided as an example. Other examples may differ from what is described with respect to FIG. 6.

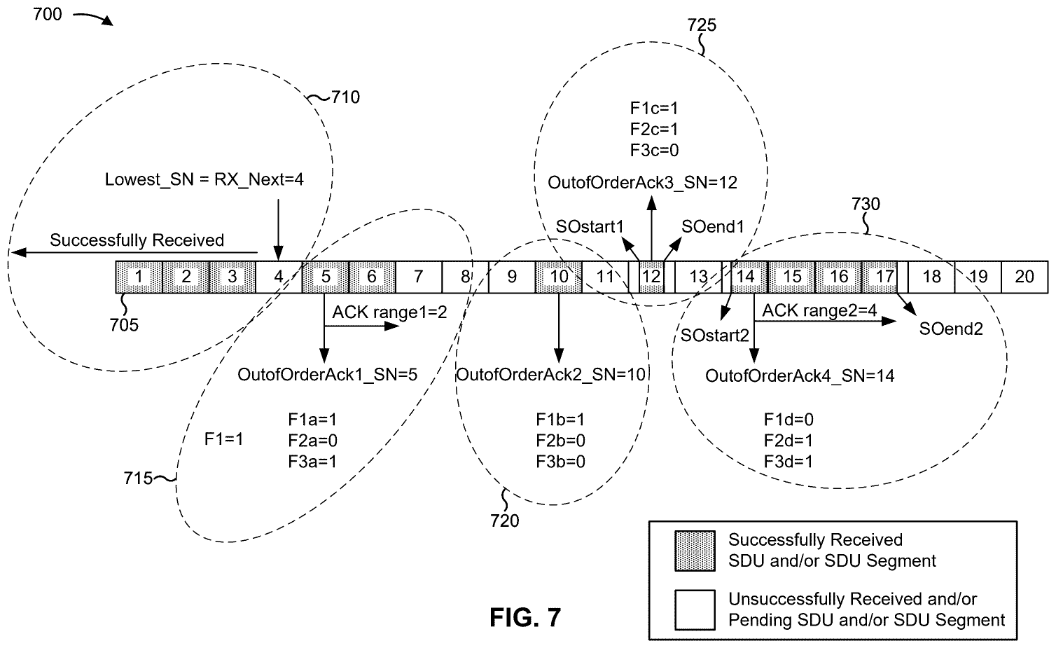

FIG. 7 is a diagram illustrating an example 700 associated with ACK status reporting, in accordance with the present disclosure. The example 700 illustrates a set of RLC packets 705 and corresponding RLC status report fields and/or indications. The set of RLC packets 705 correspond to sequence numbers 1 through 20. Although the example 700 illustrates a set of RLC packets 705 including twenty RLC packets, an RLC status report may be generated and transmitted for any quantity of RLC packets. As described with reference to FIG. 6, a Tx device may transmit, and an Rx device may receive, the set of RLC packets 705. The Rx device may generate and/or format an RLC status report based on the set of RLC packets 705 being communicated. The example 700 may include a first section 710, a second section 715, a third section 720, a fourth section 725, and a fifth section 730, each of which may be used by the Rx device to generate an RLC status report corresponding to the set of RLC packets 705.

The set of RLC packets 705 may include pending RLC packets/or unsuccessfully received and/or decoded RLC packets. Pending RLC packets may be recovered via one or more HARQ processes as described herein elsewhere without performing an ARQ procedure. Unsuccessfully received and/or decoded RLC packets may be cause by unsuccessful HARQ termination and may be recovered by performing an ARQ procedure. Unsuccessful HARQ termination may be reported separately (e.g., via one or more MAC-CE functionalities as described with reference to FIG. 4), thus the Tx device may refrain from triggering an ARQ in response to receiving the ACK-specific RLC status report. Based on receiving the RLC status report, the Tx device may empty/reduce the Tx buffer. The RLC status report may include an ACK for any successfully received RLC packet and/or packet segment even when the corresponding packets are received out-of-sequence. Additionally or alternatively, the RLC status report may include an ACK for a received RLC packet corresponding to a highest sequence number (of all sequence numbers corresponding to successfully received RLC packets).

For example, the first section 710 may include a first RLC packet 705-4, associated with a first sequence number (e.g., Lowest_SN=4 in the example 700) that is pending and/or unsuccessfully received. The first sequence number nay be a lowest sequence number corresponding to a pending and/or unsuccessfully received RLC packet of all sequence numbers associated with the set of packets 705. For example, RLC packet 705-4 may be associated with a first occurring sequence number (e.g., 4 in the example 700) for a packet that was not successfully received. In such examples, other pending and/or unsuccessfully received RLC packets may have sequence numbers higher than the RLC packet.

In the first section 710, the RLC packets 705-1 through 705-3 may be successfully received by the Rx device and thus, the RLC status report may include an indication (e.g., lowest_SN) that all RLC packets 705-1, 705-2, and 705-3, of the set of RLC packets 705, having sequence numbers less than the first sequence number (e.g., 4) were successfully received by the Rx device. In some examples, the indication may include an information element, such as “RX_Next” that may indicate that that all RLC packets, of the set of RLC packets 705, having sequence numbers less than and not equal to the first sequence number were successfully received. In the example 700, RX_Next=4. In some other examples, the indication may include an information element, such as “RX_Next−1” that may indicate that that all RLC packets, of the set of RLC packets 705, having sequence numbers less than or equal to the first sequence number were successfully received. In the example 700, RX_Next-1=3.

The RLC status report may thus include a first field (e.g., F1) and a set of indications (e.g., F1, F2, F3) associated with each out-of-order packet decoded by the Rx device. F1 may indicate whether the set of RLC packets 705 includes at least one inconsecutively received RLC packet (e.g., OutofOrderAck1_SN) and/or may indicate whether the RLC status report includes an additional inconsecutively received RLC packet (e.g., additional with respect to the out-of-order packet corresponding to F1) (e.g., OutofOrderAck2_SN). F2 may indicate whether the second sequence number and/or a sequence number within an indicated range of the second sequence number is partially received. For example, F2 may indicate whether a corresponding segmentation offset start indication (e.g., indicating the beginning of a successfully received packet segment), such as SOstart and/or a corresponding segmentation offset end indication (e.g., indicating the end of a successfully received packet segment), such as SOend are included in the RLC status report. F3 may indicate whether a corresponding ACK range field (e.g., ACK range field (e.g., ACK_range) corresponding to the OutofOrderAck_SN) is included in the RLC report.

The second section 715 may include a second RLC packet 705-5 which may be a first inconsecutively received RLC packet. The second RLC packet 705-5 may be associated with a second sequence number (e.g., OutofOrderAck1_SN=5). Thus, the RLC status report may include a first F1 having a value “1” because the set of RLC packets 705 includes at least one inconsecutively received RLC packet. The RLC status report may additionally include a set of indications Fla, F2a, and F3a corresponding to the second RLC packet 705-5. According to the example 700, the RLC status report may indicate F1a=1 because the set of RLC packets 705 includes an additional inconsecutively received RLC packet 705-10. The RLC status report may indicate F2a=0 because each of RLC packet 705-5 and 705-6 are fully decoded (e.g., indicating that the report will not include segmentation offset indications corresponding to the RLC packet 705-5). The RLC status report may indicate F3a=1 because, starting with RLC packet 705-5, the set of RLC packets 705 (e.g., in the second portion 715) includes two consecutive RLC packets (e.g., RLC packets 705-5 and 705-6) of which at least one segment was successfully received. Thus, the RLC status report will include an ACK range indication corresponding to RLC packet 705-5 (e.g., corresponding to OutofOrderAck1_SN=5). In the second portion 715, the ACK range (e.g., ACK range1) has a value of 2.

The third section 720 may include a third RLC packet 705-10 which may be a second inconsecutively received RLC packet. The third RLC packet 705-10 may be associated with a third sequence number (e.g., OutofOrderAck2_SN=10). Thus, the RLC status report may include a set of indications F1b, F2b, and F3b corresponding to the third RLC packet 705-10. According to the example 700, the RLC status report may indicate F1b=1 because the set of RLC packets 705 includes an additional inconsecutively received RLC packet 705-12. The RLC status report may indicate F2b=0 because RLC packet 705-10 is fully decoded (e.g., indicating that the report will not include segmentation offset indications corresponding to the RLC packet 705-10). The RLC status report may indicate F3b=0 because, starting with RLC packet 705-10, the set of RLC packets 705 (e.g., in the third portion 720) does not include consecutively received RLC packets (e.g., RLC packet 705-11 is pending and/or unsuccessfully received). Thus, the RLC status report will omit an ACK range indication corresponding to RLC packet 705-10 (e.g., corresponding to OutofOrderAck2_SN=10).

The fourth section 725 may include a fourth RLC packet 705-12 which may be a third inconsecutively received RLC packet. The fourth RLC packet 705-12 may be associated with a fourth sequence number (e.g., OutofOrderAck3_SN=12). Thus, the RLC status report may include a set of indications F1c, F2c, and F3c corresponding to the fourth RLC packet 705-12. According to the example 700, the RLC status report may indicate F1c=1 because the set of RLC packets 705 includes an additional inconsecutively received RLC packet 705-14. The RLC status report may indicate F2c=1 because RLC packet 705-12 is partially decoded (e.g., indicating that the report will include segmentation offset indications corresponding to the RLC packet 705-12). For example, the corresponding segmentation offset start indication, SOstart1 and/or the corresponding segmentation offset end indication, SOend1 indicate that the RLC packet segment within the RLC packet 705-12 having the fourth sequence number is successfully received. The RLC status report may indicate F3c=0 because, starting with RLC packet 705-12, the set of RLC packets 705 (e.g., in the fourth portion 725) does not include consecutively received RLC packets (e.g., RLC packet 705-13 is pending and/or unsuccessfully received). Thus, the RLC status report will omit an ACK range indication corresponding to RLC packet 705-12 (e.g., corresponding to OutofOrderAck3_SN=12).

The fifth section 730 may include a fifth RLC packet 705-14 which may be a fourth inconsecutively received RLC packet. The fifth RLC packet 705-14 may be associated with a fifth sequence number (e.g., OutofOrderAck4_SN=14). Thus, the RLC status report may include a set of indications F1d, F2d, and F3d corresponding to the fifth RLC packet 705-14. According to the example 700, the RLC status report may indicate F1d=0 because the fifth RLC packet 705-14 is a lastly occurring inconsecutively received RLC packet (e.g., the set of RLC packets 705 does not include an additional inconsecutively received RLC packet having a sequence number greater than fifth RLC packet 705-14). The RLC status report may indicate F2d=1 because RLC packet 705-14 is partially decoded (e.g., indicating that the report will include segmentation offset indications corresponding to the RLC packet 705-14). The RLC status report may indicate F3d=1 because, starting with RLC packet 705-14, the set of RLC packets 705 (e.g., in the fifth portion 730) includes four consecutive RLC packets (e.g., RLC packets 705-15 through 705-17) of which at least one segment was successfully received. Thus, the RLC status report may include an ACK range indication corresponding to RLC packet 705-14 (e.g., corresponding to OutofOrderAck4_SN=14). In the fifth portion 730, the ACK range (e.g., ACK range2) has a value of 4.

Because the fifth portion 730 includes F2d=1 and F3d=1, the corresponding segmentation offset start indication (e.g., SOstart2) refers to a start of a segment in the fifth RLC packet 705-14 having the fifth sequence number, and the corresponding segmentation offset end indication (e.g., SOend2) refers to the end of a segment in a sixth RLC packet 705-17 (e.g., the RLC packet having a sequence number greater than the fifth sequence number by the indicated range (e.g., 4) minus one (e.g., OutofOrderAck4_SN+ACK range2−1=17)) having a sixth sequence number (e.g., 17).

As indicated above, FIG. 7 is provided as an example. Other examples may differ from what is described with respect to FIG. 7.

FIG. 8 is a diagram illustrating an example process 800 performed, for example, at a receiver or an apparatus of a receiver, in accordance with the present disclosure. Example process 800 is an example where the apparatus or the receiver (e.g., Rx device 605 as described with reference to FIG. 6) performs operations associated with an ACK status report.

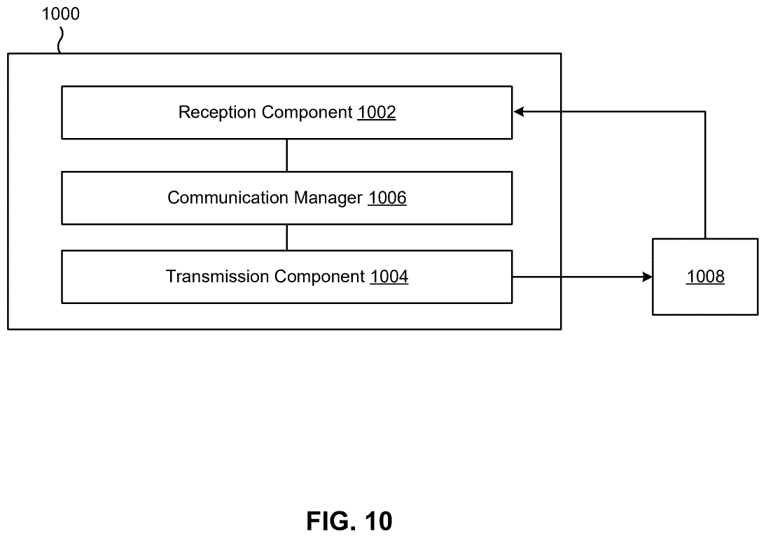

As shown in FIG. 8, in some aspects, process 800 may include receiving a set of RLC packets (block 810). For example, the receiver (e.g., using reception component 1002 and/or communication manager 1006, depicted in FIG. 10) may receive a set of RLC packets, as described above in connection with reference number 630 of FIG. 6.

As further shown in FIG. 8, in some aspects, process 800 may include transmitting an RLC status report that includes a first sequence number of an RLC packet of the set of RLC packets, the first sequence number indicating that all RLC packets, of the set of RLC packets, having sequence numbers less than the first sequence number were successfully received by the receiver (block 820). For example, the receiver (e.g., using transmission component 1004 and/or communication manager 1006, depicted in FIG. 10) may transmit an RLC status report that includes a first sequence number of an RLC packet of the set of RLC packets, the first sequence number indicating that all RLC packets, of the set of RLC packets, having sequence numbers less than the first sequence number were successfully received by the receiver, as described above in connection with reference number 640 of FIG. 6.

Process 800 may include additional aspects, such as any single aspect or any combination of aspects described below and/or in connection with one or more other processes described elsewhere herein.

In a first aspect, process 800 includes receiving at least one RLC packet including a polling bit that indicates a requested type of RLC status report.

In a second aspect, alone or in combination with the first aspect, transmitting the RLC status report is associated with the polling bit including a request for at least one of an ACK status report, or an ACK/NACK status report.

In a third aspect, alone or in combination with one or more of the first and second aspects, transmitting the RLC status report includes transmitting the RLC status report in accordance with a periodic schedule.

In a fourth aspect, alone or in combination with one or more of the first through third aspects, the RLC status report includes a second sequence number of a second RLC packet of the set of RLC packets, the second sequence number indicating that at least a segment, of the second RLC packet having the second sequence number, was successfully received.

In a fifth aspect, alone or in combination with one or more of the first through fourth aspects, the second sequence number is greater than the first sequence number.

In a sixth aspect, alone or in combination with one or more of the first through fifth aspects, the first sequence number and the second sequence number are inconsecutive.

In a seventh aspect, alone or in combination with one or more of the first through sixth aspects, the RLC status report includes a set of indications corresponding to the second sequence number, the set of indications including at least one of an indication of whether the RLC status report includes the second sequence number, an indication of a whether the RLC status report includes a third sequence number indicating that a third RLC packet associated with the third sequence number was successfully received, an indication of whether the RLC status report includes a segmentation offset indication corresponding to the second sequence number, or an indication of whether the RLC status report includes a range indication corresponding to the second sequence number.

In an eighth aspect, alone or in combination with one or more of the first through seventh aspects, the RLC status report includes a range indication that indicates a quantity of consecutive RLC packets, including the second RLC packet and associated with corresponding sequence numbers greater than or equal to the second sequence number, for which at least a segment of each packet was successfully received.

In a ninth aspect, alone or in combination with one or more of the first through eighth aspects, the RLC status report includes a segmentation offset indication that indicates that at least one of the second RLC packet or a third RLC packet within an indicated range of the second RLC packet was partially received.

In a tenth aspect, alone or in combination with one or more of the first through ninth aspects, the second sequence number corresponds to a highest sequence number for which at least a segment of a corresponding packet was successfully received.

In an eleventh aspect, alone or in combination with one or more of the first through tenth aspects, transmitting the RLC status report includes transmitting control signaling including the RLC status report.

In a twelfth aspect, alone or in combination with one or more of the first through eleventh aspects, the control signaling includes at least one of RLC signaling, or a MAC signaling.

In a thirteenth aspect, alone or in combination with one or more of the first through twelfth aspects, the first sequence number indicates that all RLC packets, of the set of RLC packets, having sequence numbers less than or equal to the first sequence number were successfully received by the receiver.

In a fourteenth aspect, alone or in combination with one or more of the first through thirteenth aspects, the RLC status report includes a field indicating that the RLC status report is an ACK report.

In a fifteenth aspect, alone or in combination with one or more of the first through fourteenth aspects, the field includes at least one of a control packet type field or a header.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a transmitter or an apparatus of a transmitter, in accordance with the present disclosure. Example process 900 is an example where the apparatus or the transmitter (e.g., Tx device 610 as described with reference to FIG. 6) performs operations associated with an ACK status report.

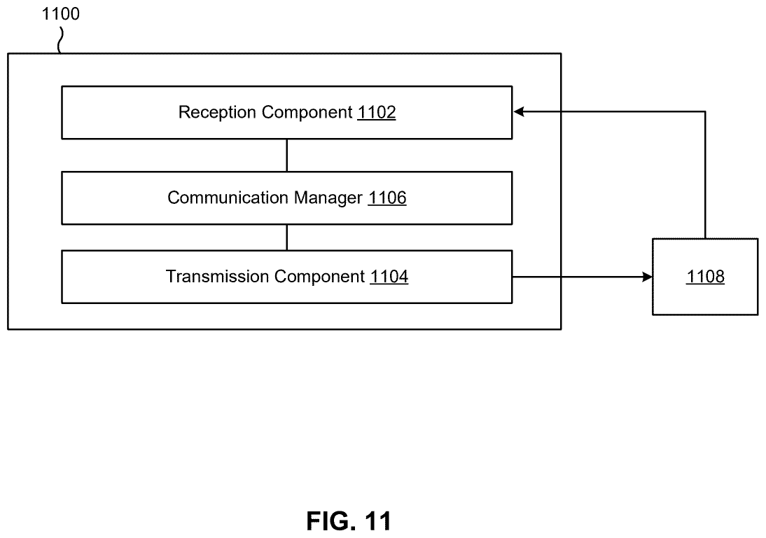

As shown in FIG. 9, in some aspects, process 900 may include transmitting a set of RLC packets (block 910). For example, the transmitter (e.g., using transmission component 1104 and/or communication manager 1106, depicted in FIG. 11) may transmit a set of RLC packets, as described above in connection with reference number 630 of FIG. 6.

As further shown in FIG. 9, in some aspects, process 900 may include receiving an RLC status report that includes a first sequence number of an RLC packet of the set of RLC packets, the first sequence number indicating that all RLC packets, of the set of RLC packets, having sequence numbers less than the first sequence number were successfully received by a receiver (block 920). For example, the transmitter (e.g., using reception component 1102 and/or communication manager 1106, depicted in FIG. 11) may receive an RLC status report that includes a first sequence number of an RLC packet of the set of RLC packets, the first sequence number indicating that all RLC packets, of the set of RLC packets, having sequence numbers less than the first sequence number were successfully received by a receiver, as described above in connection with reference number 640 of FIG. 6.

Process 900 may include additional aspects, such as any single aspect or any combination of aspects described below and/or in connection with one or more other processes described elsewhere herein.

In a first aspect, process 900 includes transmitting at least one RLC packet including a polling bit that indicates a requested type of RLC status report.

In a second aspect, alone or in combination with the first aspect, receiving the RLC status report is associated with the polling bit indicating a request for at least one of an ACK status report, or an ACK/NACK status report.

In a third aspect, alone or in combination with one or more of the first and second aspects, receiving the RLC status report comprises receiving the RLC status report in accordance with a periodic schedule.

In a fourth aspect, alone or in combination with one or more of the first through third aspects, the RLC status report includes a second sequence number of a second RLC packet of the set of RLC packets, the second sequence number indicating that at least a segment, of the second RLC packet having the second sequence number, was successfully received.

In a fifth aspect, alone or in combination with one or more of the first through fourth aspects, the second sequence number is greater than the first sequence number.

In a sixth aspect, alone or in combination with one or more of the first through fifth aspects, the first sequence number and the second sequence number are inconsecutive.

In a seventh aspect, alone or in combination with one or more of the first through sixth aspects, the RLC status report includes a set of indications corresponding to the second sequence number, the set of indications including at least one of an indication of whether the RLC status report includes the second sequence number, an indication of a whether the RLC status report includes a third sequence number indicating that a third RLC packet associated with the third sequence number was successfully received, an indication of whether the RLC status report includes a segmentation offset indication corresponding to the second sequence number, or an indication of whether the RLC status report includes a range indication corresponding to the second sequence number.

In an eighth aspect, alone or in combination with one or more of the first through seventh aspects, the RLC status report includes a range indication that indicates a quantity of consecutive RLC packets, including the second RLC packet and associated with corresponding sequence numbers greater than or equal to the second sequence number, for which at least a segment of each packet was successfully received.

In a ninth aspect, alone or in combination with one or more of the first through eighth aspects, the RLC status report includes a segmentation offset indication that indicates at least one of the second RLC packet or a third RLC packet within an indicated range of the second RLC packet was partially received.

In a tenth aspect, alone or in combination with one or more of the first through ninth aspects, the second sequence number corresponds to a highest sequence number for which at least a segment of a corresponding packet was successfully received.

In an eleventh aspect, alone or in combination with one or more of the first through tenth aspects, receiving the RLC status report comprises receiving control signaling including the RLC status report.

In a twelfth aspect, alone or in combination with one or more of the first through eleventh aspects, the control signaling comprises at least one of RLC signaling, or a medium access control signaling.

In a thirteenth aspect, alone or in combination with one or more of the first through twelfth aspects, the first sequence number indicates that all RLC packets, of the set of RLC packets, having sequence numbers less than or equal to the first sequence number were successfully received by the receiver.

In a fourteenth aspect, alone or in combination with one or more of the first through thirteenth aspects, the RLC status report includes a field indicating that the RLC status report is an ACK report.

In a fifteenth aspect, alone or in combination with one or more of the first through fourteenth aspects, the field includes at least one of a control packet type field or a header.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a receiver, or a receiver may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 and/or the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 6-7. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the receiver described in connection with FIG. 1 and FIG. 2. Additionally, or alternatively, one or more components shown in FIG. 10 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the receiver described in connection with FIG. 1 and FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the receiver described in connection with FIG. 1 and FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive a set of RLC packets. The transmission component 1004 may transmit an RLC status report that includes a first sequence number of an RLC packet of the set of RLC packets, the first sequence number indicating that all RLC packets, of the set of RLC packets, having sequence numbers less than the first sequence number were successfully received by the receiver.

The reception component 1002 may receive at least one RLC packet including a polling bit that indicates a requested type of RLC status report. The transmission component 1004 may transmit the RLC status report in accordance with a periodic schedule. The transmission component 1004 may transmit control signaling including the RLC status report.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a transmitter, or a transmitter may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 and/or the communication manager 140, described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 6-7. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the transmitter described in connection with FIG. 1 and FIG. 2. Additionally, or alternatively, one or more components shown in FIG. 11 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the transmitter described in connection with FIG. 1 and FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the transmitter described in connection with FIG. 1 and FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit a set of RLC packets. The reception component 1102 may receive an RLC status report that includes a first sequence number of an RLC packet of the set of RLC packets, the first sequence number indicating that all RLC packets, of the set of RLC packets, having sequence numbers less than the first sequence number were successfully received by a receiver.

The transmission component 1104 may transmit at least one RLC packet including a polling bit that indicates a requested type of RLC status report. The reception component 1102 may receive the RLC status report in accordance with a periodic schedule. The reception component 1102 may receive control signaling including the RLC status report.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a receiver, comprising: receiving a set of radio link control (RLC) packets; and transmitting an RLC status report that includes a first sequence number of an RLC packet of the set of RLC packets, the first sequence number indicating that all RLC packets, of the set of RLC packets, having sequence numbers less than the first sequence number were successfully received by the receiver.
Aspect 2: The method of Aspect 1, further comprising: receiving at least one RLC packet including a polling bit that indicates a requested type of RLC status report.
Aspect 3: The method of Aspect 2, wherein transmitting the RLC status report is associated with the polling bit including a request for at least one of an acknowledgement status report, or an acknowledgement/negative acknowledgement status report.
Aspect 4: The method of any of Aspects 1-3, wherein transmitting the RLC status report comprises: transmitting the RLC status report in accordance with a periodic schedule.
Aspect 5: The method of any of Aspects 1-4, wherein the RLC status report includes a second sequence number of a second RLC packet of the set of RLC packets, the second sequence number indicating that at least a segment, of the second RLC packet having the second sequence number, was successfully received.
Aspect 6: The method of Aspect 5, wherein the second sequence number is greater than the first sequence number.
Aspect 7: The method of any of Aspects 5-6, wherein the first sequence number and the second sequence number are inconsecutive.
Aspect 8: The method of any of Aspects 5-7, wherein the RLC status report includes a set of indications corresponding to the second sequence number, the set of indications including at least one of: an indication of whether the RLC status report includes the second sequence number, an indication of a whether the RLC status report includes a third sequence number indicating that a third RLC packet associated with the third sequence number was successfully received, an indication of whether the RLC status report includes a segmentation offset indication corresponding to the second sequence number, or an indication of whether the RLC status report includes a range indication corresponding to the second sequence number.
Aspect 9: The method of any of Aspects 5-8, wherein the RLC status report includes a range indication that indicates a quantity of consecutive RLC packets, including the second RLC packet and associated with corresponding sequence numbers greater than or equal to the second sequence number, for which at least a segment of each packet was successfully received.
Aspect 10: The method of any of Aspects 5-9, wherein the RLC status report includes a segmentation offset indication that indicates that at least one of the second RLC packet or a third RLC packet within an indicated range of the second RLC packet was partially received.
Aspect 11: The method of any of Aspects 5-10, wherein the second sequence number corresponds to a highest sequence number for which at least a segment of a corresponding packet was successfully received.
Aspect 12: The method of any of Aspects 1-11, wherein transmitting the RLC status report comprises: transmitting control signaling including the RLC status report.
Aspect 13: The method of Aspect 12, wherein the control signaling comprises at least one of RLC signaling, or a medium access control signaling.
Aspect 14: The method of any of Aspects 1-13, wherein the first sequence number indicates that all RLC packets, of the set of RLC packets, having sequence numbers less than or equal to the first sequence number were successfully received by the receiver.
Aspect 15: The method of any of Aspects 1-14, wherein the RLC status report includes a field indicating that the RLC status report is an acknowledgement report.
Aspect 16: The method of Aspect 15, wherein the field includes at least one of a control packet type field or a header.
Aspect 17: A method of wireless communication performed by a transmitter, comprising: transmitting a set of radio link control (RLC) packets; and receiving an RLC status report that includes a first sequence number of an RLC packet of the set of RLC packets, the first sequence number indicating that all RLC packets, of the set of RLC packets, having sequence numbers less than the first sequence number were successfully received by a receiver.
Aspect 18: The method of Aspect 17, further comprising: transmitting at least one RLC packet including a polling bit that indicates a requested type of RLC status report.
Aspect 19: The method of Aspect 18, wherein receiving the RLC status report is associated with the polling bit indicating a request for at least one of an acknowledgement status report, or an acknowledgement/negative acknowledgement status report.
Aspect 20: The method of any of Aspects 17-19, wherein receiving the RLC status report comprises: receiving the RLC status report in accordance with a periodic schedule.
Aspect 21: The method of any of Aspects 17-20, wherein the RLC status report includes a second sequence number of a second RLC packet of the set of RLC packets, the second sequence number indicating that at least a segment, of the second RLC packet having the second sequence number, was successfully received.
Aspect 22: The method of Aspect 21, wherein the second sequence number is greater than the first sequence number.
Aspect 23: The method of any of Aspects 21-22, wherein the first sequence number and the second sequence number are inconsecutive.
Aspect 24: The method of any of Aspects 21-23, wherein the RLC status report includes a set of indications corresponding to the second sequence number, the set of indications including at least one of: an indication of whether the RLC status report includes the second sequence number, an indication of a whether the RLC status report includes a third sequence number indicating that a third RLC packet associated with the third sequence number was successfully received, an indication of whether the RLC status report includes a segmentation offset indication corresponding to the second sequence number, or an indication of whether the RLC status report includes a range indication corresponding to the second sequence number.
Aspect 25: The method of any of Aspects 21-24, wherein the RLC status report includes a range indication that indicates a quantity of consecutive RLC packets, including the second RLC packet and associated with corresponding sequence numbers greater than or equal to the second sequence number, for which at least a segment of each packet was successfully received.
Aspect 26: The method of any of Aspects 21-25, wherein the RLC status report includes a segmentation offset indication that indicates at least one of the second RLC packet or a third RLC packet within an indicated range of the second RLC packet was partially received.
Aspect 27: The method of any of Aspects 21-26, wherein the second sequence number corresponds to a highest sequence number for which at least a segment of a corresponding packet was successfully received.
Aspect 28: The method of any of Aspects 17-27, wherein receiving the RLC status report comprises: receiving control signaling including the RLC status report.
Aspect 29: The method of Aspect 28, wherein the control signaling comprises at least one of RLC signaling, or a medium access control signaling.
Aspect 30: The method of any of Aspects 17-29, wherein the first sequence number indicates that all RLC packets, of the set of RLC packets, having sequence numbers less than or equal to the first sequence number were successfully received by the receiver.
Aspect 31: The method of any of Aspects 17-30, wherein the RLC status report includes a field indicating that the RLC status report is an acknowledgement report.
Aspect 32: The method of Aspect 31, wherein the field includes at least one of a control packet type field or a header.
Aspect 33: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-32.
Aspect 34: An apparatus for wireless communication at a device, the apparatus comprising one or more memories and one or more processors coupled to the one or more memories, the one or more processors configured to cause the device to perform the method of one or more of Aspects 1-32.
Aspect 35: An apparatus for wireless communication, the apparatus comprising at least one means for performing the method of one or more of Aspects 1-32.
Aspect 36: A non-transitory computer-readable medium storing code for wireless communication, the code comprising instructions executable by one or more processors to perform the method of one or more of Aspects 1-32.
Aspect 37: A non-transitory computer-readable medium storing a set of instructions for wireless communication, the set of instructions comprising one or more instructions that, when executed by one or more processors of a device, cause the device to perform the method of one or more of Aspects 1-32.
Aspect 38: A device for wireless communication, the device comprising a processing system that includes one or more processors and one or more memories coupled with the one or more processors, the processing system configured to cause the device to perform the method of one or more of Aspects 1-32.
Aspect 39: An apparatus for wireless communication at a device, the apparatus comprising one or more memories and one or more processors coupled to the one or more memories, the one or more processors individually or collectively configured to cause the device to perform the method of one or more of Aspects 1-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a receiver, comprising:
one or more memories; and
one or more processors, coupled to the one or more memories, configured to cause the receiver to:
receive a set of radio link control (RLC) packets; and
transmit an RLC status report that includes a first sequence number of an RLC packet of the set of RLC packets, the first sequence number indicating that all RLC packets, of the set of RLC packets, having sequence numbers less than the first sequence number were successfully received by the receiver.

2. The apparatus of claim 1, wherein the one or more processors are further configured to cause the receiver to:
receive at least one RLC packet including a polling bit that indicates a requested type of RLC status report.

3. The apparatus of claim 2, wherein transmitting the RLC status report is associated with the polling bit including a request for at least one of an acknowledgement status report, or an acknowledgement/negative acknowledgement status report.

4. The apparatus of claim 1, wherein the one or more processors, to cause the receiver to transmit the RLC status report, are configured to cause the receiver to:
transmit the RLC status report in accordance with a periodic schedule.

5. The apparatus of claim 1, wherein the one or more processors, to cause the receiver to transmit the RLC status report, are configured to cause the receiver to:
transmit control signaling including the RLC status report.

6. The apparatus of claim 5, wherein the control signaling comprises at least one of RLC signaling, or a medium access control signaling.

7. The apparatus of claim 1, wherein the first sequence number indicates that all RLC packets, of the set of RLC packets, having sequence numbers less than or equal to the first sequence number were successfully received by the receiver.

8. The apparatus of claim 1, wherein the RLC status report includes a field indicating that the RLC status report is an acknowledgement report.

9. An apparatus for wireless communication at a transmitter, comprising:
one or more memories; and
one or more processors, coupled to the one or more memories, configured to cause the transmitter to:
transmit a set of radio link control (RLC) packets; and
receive an RLC status report that includes a first sequence number of an RLC packet of the set of RLC packets, the first sequence number indicating that all RLC packets, of the set of RLC packets, having sequence numbers less than the first sequence number were successfully received by a receiver.

10. The apparatus of claim 9, wherein the one or more processors are further configured to cause the transmitter to:
transmit at least one RLC packet including a polling bit that indicates a requested type of RLC status report.

11. The apparatus of claim 10, wherein receiving the RLC status report is associated with the polling bit indicating a request for at least one of an acknowledgement status report, or an acknowledgement/negative acknowledgement status report.

12. The apparatus of claim 9, wherein the one or more processors, to cause the transmitter to receive the RLC status report, are configured to cause the transmitter to:
receive the RLC status report in accordance with a periodic schedule.

13. The apparatus of claim 9, wherein the one or more processors, to cause the transmitter to receive the RLC status report, are configured to cause the transmitter to:
receive control signaling including the RLC status report.

14. The apparatus of claim 9, wherein the first sequence number indicates that all RLC packets, of the set of RLC packets, having sequence numbers less than or equal to the first sequence number were successfully received by the receiver.

15. The apparatus of claim 9, wherein the RLC status report includes a field indicating that the RLC status report is an acknowledgement report.

16. The apparatus of claim 15, wherein the field includes at least one of a control packet type field or a header.

17. A method of wireless communication performed by a receiver, comprising:
receiving a set of radio link control (RLC) packets; and
transmitting an RLC status report that includes a first sequence number of an RLC packet of the set of RLC packets, the first sequence number indicating that all RLC packets, of the set of RLC packets, having sequence numbers less than the first sequence number were successfully received by the receiver.

18. The method of claim 17, wherein the RLC status report includes a second sequence number of a second RLC packet of the set of RLC packets, the second sequence number indicating that at least a segment, of the second RLC packet having the second sequence number, was successfully received.

19. The method of claim 18, wherein the second sequence number is greater than the first sequence number.

20. The method of claim 18, wherein the first sequence number and the second sequence number are inconsecutive.

21. The method of claim 18, wherein the RLC status report includes a set of indications corresponding to the second sequence number, the set of indications including at least one of:
an indication of whether the RLC status report includes the second sequence number,
an indication of a whether the RLC status report includes a third sequence number indicating that a third RLC packet associated with the third sequence number was successfully received,
an indication of whether the RLC status report includes a segmentation offset indication corresponding to the second sequence number, or
an indication of whether the RLC status report includes a range indication corresponding to the second sequence number.

22. The method of claim 18, wherein the RLC status report includes a range indication that indicates a quantity of consecutive RLC packets, including the second RLC packet and associated with corresponding sequence numbers greater than or equal to the second sequence number, for which at least a segment of each packet was successfully received.

23. The method of claim 18, wherein the RLC status report includes a segmentation offset indication that indicates that at least one of the second RLC packet or a third RLC packet within an indicated range of the second RLC packet was partially received.

24. The method of claim 18, wherein the second sequence number corresponds to a highest sequence number for which at least a segment of a corresponding packet was successfully received.

25. A method of wireless communication performed by a transmitter, comprising:
transmitting a set of radio link control (RLC) packets; and
receiving an RLC status report that includes a first sequence number of an RLC packet of the set of RLC packets, the first sequence number indicating that all RLC packets, of the set of RLC packets, having sequence numbers less than the first sequence number were successfully received by a receiver.

26. The method of claim 25, wherein the RLC status report includes a second sequence number of a second RLC packet of the set of RLC packets, the second sequence number indicating that at least a segment, of the second RLC packet having the second sequence number, was successfully received.

27. The method of claim 26, wherein the RLC status report includes a set of indications corresponding to the second sequence number, the set of indications including at least one of:
an indication of whether the RLC status report includes the second sequence number,
an indication of a whether the RLC status report includes a third sequence number indicating that a third RLC packet associated with the third sequence number was successfully received,
an indication of whether the RLC status report includes a segmentation offset indication corresponding to the second sequence number, or
an indication of whether the RLC status report includes a range indication corresponding to the second sequence number.

28. The method of claim 26, wherein the RLC status report includes a range indication that indicates a quantity of consecutive RLC packets, including the second RLC packet and associated with corresponding sequence numbers greater than or equal to the second sequence number, for which at least a segment of each packet was successfully received.

29. The method of claim 26, wherein the RLC status report includes a segmentation offset indication that indicates at least one of the second RLC packet or a third RLC packet within an indicated range of the second RLC packet was partially received.

30. The method of claim 26, wherein the second sequence number corresponds to a highest sequence number for which at least a segment of a corresponding packet was successfully received.
